(19) United States
(12) Patent Application Publication
(10) Pub. No.: US 2023/0168265 A1
(43) Pub. Date: Jun. 1, 2023

(54) AUTOMATIC ANALYZING APPARATUS

(71) Applicant: CANON MEDICAL SYSTEMS CORPORATION, Otawara-shi (JP)

(72) Inventor: Shozo HASHIMOTO, Nasushiobara (JP)

(73) Assignee: CANON MEDICAL SYSTEMS CORPORATION, Otawara-shi (JP)

(21) Appl. No.: 18/059,464

(22) Filed: Nov. 29, 2022

(30) Foreign Application Priority Data
Nov. 30, 2021 (JP) 2021-194924

(51) Int. Cl. G01N 35/10; G01N 35/02; G01N 35/00

(52) U.S. Cl. CPC G01N 35/1002; G01N 35/02; G01N 35/00584

(57) ABSTRACT

An automatic analyzing apparatus comprises a reaction disk on which a reaction tube is placed, a reaction tube transportation mechanism that transports the reaction tube, a controller that controls the reaction tube transportation mechanism to transport the reaction tube to at least one of a sample dispensing position and a reagent dispensing position, the sample dispensing position being a position where a sample is dispensed and the reagent dispensing position being a position where a reagent is dispensed, and transport to the reaction disk the reaction tube for which at least one of the sample and the reagent is dispensed.

### CROSS REFERENCE TO RELATED APPLICATIONS

This application is based upon and claims the benefit of priority from the prior Japanese Patent Application No. 2021-194924, filed on Nov. 30, 2021, the entire contents of which are incorporated herein by reference.

### FIELD

The embodiments disclosed in the present specification, drawings relate to an automatic analyzing apparatus.

### BACKGROUND

An automatic analyzing apparatus is an apparatus that, for instance, optically measures a liquid mixture, which may be obtained by mixing a sample such as a subject sample collected from a subject such as a blood or a standard sample of each inspection item with a reagent that corresponds to each inspection item, and analyzes ingredients of a subject sample corresponding to each inspection item.

Conventionally, automatic analyzing apparatuses comprise a sample dispensing probe and a reagent dispensing probe in order to dispense samples and reagents to a reaction tube placed on a reaction disk. Likewise, such automatic analyzing apparatuses are required to provide a moving mechanism in a horizontal direction in order to move the sample dispensing probe and the reagent dispensing probe to a placement position of the reaction tube placed on the reaction disk. However, providing the moving mechanism in the horizontal direction to each of the sample dispensing probe and the reagent dispensing probe increases a number of parts of the automatic analyzing apparatus, which may make miniaturizing the automatic analyzing apparatus difficult.

Likewise, the automatic analyzing apparatus is required to dispense the sample by bringing a tip of the sample dispensing probe in contact with a bottom portion of the reaction tube in order to dispense an appropriate amount of the sample to the reaction tube. As such, it is required to provide a moving mechanism, to the automatic analyzing apparatus, that vertically moves the sample dispensing probe in order to bring the tip of the sample dispensing probe in contact with the bottom portion of the reaction tube. However, providing the moving mechanism that vertically moves the sample dispensing probe increases the number of parts of the automatic analyzing apparatus, which may make the miniaturization of the automatic analyzing apparatus difficult. For this reason, it is desired to miniaturize the automatic analyzing apparatus while comprising a mechanism to dispense the sample or reagent to the reaction tube.

### BRIEF DESCRIPTION OF THE DRAWINGS

FIG. 1 is a block diagram that illustrates an exemplary functional configuration of the automatic analyzing apparatus according to a first embodiment.

FIG. 2 is a schematic diagram that illustrates a partial configuration of an analysis mechanism according to the first embodiment.

FIG. 3 is a conceptual diagram that illustrates a partial configuration of the analysis mechanism according to the first embodiment.

FIG. 4 is a conceptual diagram that describes a transportation path of a reaction tube, each position on the transportation path, and operational examples of a reaction tube transportation arm of the automatic analyzing apparatus according to the first embodiment.

FIG. 5 is a flowchart that describes a content of a reaction tube transportation control process executed in the automatic analyzing apparatus according to the first embodiment.

FIGS. 6A and 6B is a schematic diagram that schematically illustrates arrangements of the reaction tube and standard sample dispensing probe arranged on a standard sample dispensing position of the automatic analyzing apparatus according to the first embodiment.

FIGS. 7A and 7B is a schematic diagram that schematically illustrates an example of arrangements of the reaction tube and the subject sample dispensing probe arranged on a subject sample dispensing position of the automatic analyzing apparatus according to the first embodiment.

FIGS. 8A and 8B is a schematic diagram that schematically illustrates another example of arrangements of the reaction tube and the sample dispensing probe arranged on the subject sample dispensing position of the automatic analyzing apparatus according to the first embodiment.

FIG. 9A to 9C is a schematic diagram that schematically illustrates arrangements of the reaction tube and a first reagent dispensing probe arranged on a first reagent dispensing position of the automatic analyzing apparatus according to the first embodiment.

FIG. 10 is a conceptual diagram that illustrates a partial configuration of the analysis mechanism according to a second embodiment.

FIG. 11 is a conceptual diagram that describes a transportation path, each position on the transportation path of a reaction tube, and operational examples of the reaction tube transportation arm of the automatic analyzing apparatus according to the second embodiment.

FIG. 12 is a flowchart that describes a content of the reaction tube transportation control process when dispensing the standard sample, executed in the automatic analyzing apparatus according to the second embodiment.

FIG. 13 is a conceptual diagram that illustrates a partial configuration of the analysis mechanism according to a third embodiment.

FIG. 14 is a conceptual diagram that describes a transportation path, each position on the transportation path of the reaction tube, and operational examples of the reaction tube transportation arm of the automatic analyzing apparatus according to the third embodiment.

FIG. 15 is a flowchart that describes a content of the reaction tube transportation control process when dispensing the subject sample, executed in the automatic analyzing apparatus according to the third embodiment.

FIG. 16A to 16C is a schematic diagram that schematically illustrates arrangements of the reaction tube and the first reagent dispensing probe arranged on the first reagent dispensing position of the automatic analyzing apparatus according to a modified first example.

FIG. 17A to 17C is a schematic diagram that schematically illustrates arrangements of the reaction tube and the first reagent dispensing probe arranged on the first reagent dispensing position of the automatic analyzing apparatus according to a modified second example.

FIGS. 18A and 18B is a schematic diagram that schematically illustrates arrangements of the reaction tube and the first reagent dispensing probe arranged on the first reagent dispensing position of the automatic analyzing apparatus according to a modified third example.

FIG. 19A to 19C is a schematic diagram that schematically illustrates arrangements of the reaction tube and the first reagent dispensing probe arranged on the first reagent dispensing position of the automatic analyzing apparatus according to a modified fourth example.

FIG. 20A to 20C is a schematic diagram that schematically illustrates arrangements of the reaction tube and the first reagent dispensing probe arranged on the first reagent dispensing position of the automatic analyzing apparatus according to a modified fifth example.

### DETAILED DESCRIPTION

With reference to the drawings below, embodiments of an automatic analyzing apparatus will be described. Note that, in the description below, same reference signs are given for components substantially identical in terms of configuration and function, and duplicate description will be given only when necessary.

### First Embodiment

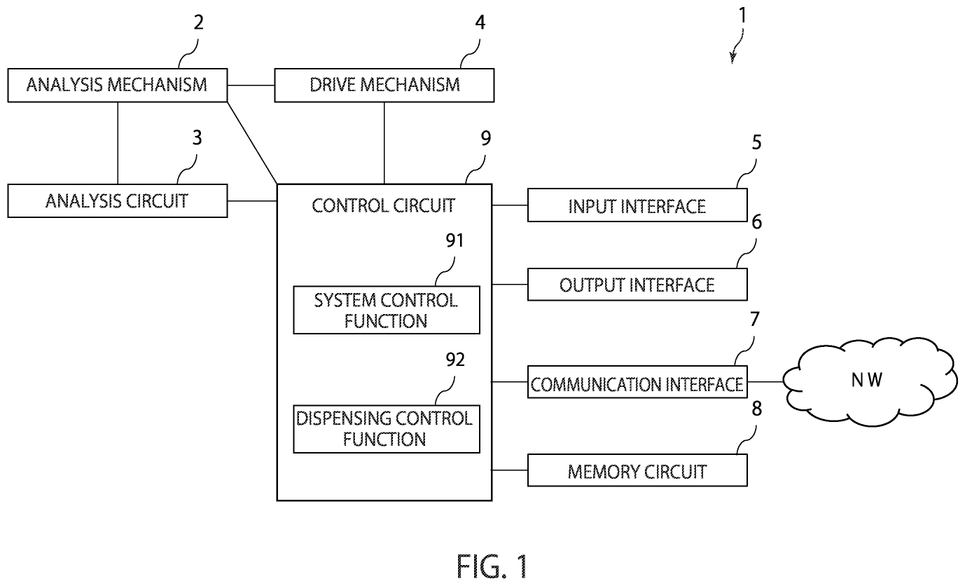

FIG. 1 is a block diagram that illustrates an exemplary functional configuration of the automatic analyzing apparatus 1 according to a first embodiment. The automatic analyzing apparatus 1 according to the present embodiment is an apparatus that, for instance, measures ingredients in the sample by measuring a liquid mixture of a sample and a reagent of a measuring target. As shown in FIG. 1, the automatic analyzing apparatus 1 according to the present embodiment, for instance, is configured comprising an analysis mechanism 2, an analysis circuit 3, a drive mechanism 4, an input interface 5, an output interface 6, a communication interface 7, a memory circuit 8, and a control circuit 9.

The analysis mechanism 2 adds the reagent used for each inspection item set for the sample to the sample, such as a standard sample or a subject sample. The analysis mechanism 2 measures a liquid mixture obtained by adding the reagent to the sample, and generates, for instance, a standard data or a subject data. In the present embodiment, the standard data represents a measurement data of an absorbance of the standard sample for which a concentration of the included detection target is known. Likewise, the subject data represents a measurement data of an absorbance of the subject sample. Note that, in the description below, the standard sample and the subject sample may be simply referred to as the “sample” when referred to without distinction.

The analysis circuit 3 is a processor that generates a calibration data or an analysis data etc., by analyzing the standard data or the subject data generated by the analysis mechanism 2. The analysis circuit 3 reads out an analysis program from the memory circuit 8 and generates the calibration data and the analysis data etc. according to the program. For instance, the analysis circuit 3 generates the calibration data that indicates a relationship between the standard data and a preset standard value for the standard sample based on the standard data. Likewise, the analysis circuit 3 generates the analysis data represented as a concentration value and an activity value of an enzyme based on the subject data and the calibration data of the inspection item corresponding to this subject data. The analysis circuit 3 outputs the generated calibration data and the analysis data to the control circuit 9.

The drive mechanism 4 drives the analysis mechanism 2 under the control of the control circuit 9. For instance, the drive mechanism 4 is realized by a gear, a stepping motor, a belt conveyer, and a lead screw etc.

The input interface 5, for instance, from a user or via an in-hospital network NW, receives settings about analysis parameters etc. of each inspection item regarding samples requested for measurement. The input interface 5, for instance, is realized by such as a mouse, a keyboard, or a touchpad for which commands are input by touching an operating screen. The input interface 5 is connected to the control circuit 9 and converts the operating command input by the user to an electrical signal to output the electrical signal to the control circuit 9. Note that, in the present embodiment, the input interface 5 is not limited to comprising a physical operating part such as the mouse or keyboard. Examples of the input interface 5 may include, for instance, an electrical signal processing circuit that receives an electrical signal corresponding to the operating command input from an external input device provided separately from the automatic analyzing apparatus 1 and outputs the electrical signal to the control circuit 9.

The output interface 6 is connected to the control circuit 9 and outputs signal supplied by the control circuit 9. The output interface 6, for instance, is realized by a display circuit, a printing circuit, and an audio device etc. The display circuit, for instance, includes a CRT display, a liquid crystal display, an organic EL display, an LED display, and a plasma display etc. Note that the display circuit also includes a processing circuit that converts data representing a display target to a video signal and externally outputs the video signal. The printing circuit, for instance, includes a printer. Note that the printing circuit also includes an output circuit which externally outputs data representing a printing target. The audio device, for instance, includes a speaker etc. Note that the audio device also includes an output circuit which externally outputs audio signals.

The communication interface 7, for instance, is connected to the in-hospital network NW, and connects the automatic analyzing apparatus 1 to the in-hospital network NW. The communication interface 7 performs data communication with the Hospital Information System (HIS) via the in-hospital network NW. Note that the communication interface 7 may as well as perform data communication with the HIS via a Laboratory Information System (LIS) connected with the in-hospital network NW.

The memory circuit 8 is configured by a storage medium readable by a processor such as a magnetic storage medium, an optical storage medium, or a semiconductor memory etc. Note that the memory circuit 8 need not necessarily have to be realized by a single storage device. For instance, the memory circuit 8 may be realized by a plurality of storage devices.

Also, the memory circuit 8 stores an analysis program executed in the analysis circuit 3 and a control program executed in the control circuit 9. The memory circuit 8 stores, for each inspection item, analysis data generated by the analysis circuit 3. The memory circuit 8 stores an inspection order input by the operator or an inspection order which the communication interface 7 received via the in-hospital network NW.

The control circuit 9 is a processor that functions as a center of the automatic analyzing apparatus 1. The control circuit 9 realizes functions corresponding to an operational program by executing the operational program stored in the memory circuit 8. For instance, the control circuit 9 realizes a system control function 91 and a dispensing control function 92 by executing the control program. Note that, in the present embodiment, a case is explained for which the system control function 91 and the dispensing control function 92 are realized by a single processor, but embodiments are not limited to this. For instance, a plurality of independent processors may be combined to configure the control circuit, and the system control function 91 and the dispensing control function 92 may be realized by each processor executing the control programs. Note that the control circuit 9 may comprise a storage area that stores at least a part of the data stored in the memory circuit 8.

The system control function 91 is a function that integrates and controls each part of the automatic analyzing apparatus 1 based on an input information input from the input interface 5. For instance, the control circuit 9 of the system control function 91, along with controlling the drive mechanism 4 and the analysis mechanism 2, controls the analysis circuit 3 so as to analyze corresponding to the inspection item. Likewise, the system control function 91, for instance, controls the dispensing control function 92 to cause the dispensing control function 92 to dispense the samples and reagents to the reaction tube. The system control function 91 configures the controller according to the present embodiment.

The dispensing control function 92 controls dispensing the samples and reagents to the reaction tube. For instance, the dispensing control function 92 controls dispensing the standard sample to the reaction tube, dispensing the subject sample to the reaction tube, or dispensing the reagent to the reaction tube in the automatic analyzing apparatus 1. The dispensing control function 92 configures the dispensing controller according to the present embodiment.

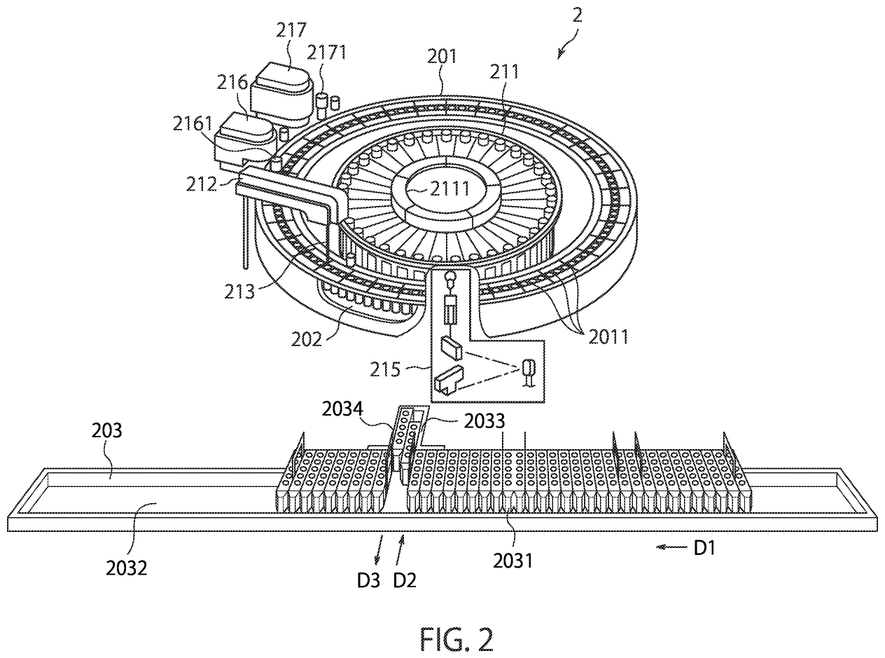

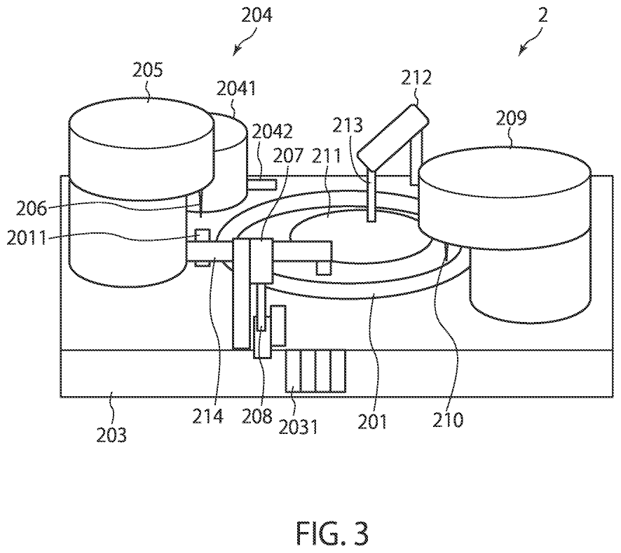

Next, based on FIGS. 2 and 3, an exemplary configuration of the analysis mechanism 2 will be described. FIG. 2 is a schematic diagram that illustrates a partial configuration of the analysis mechanism 2 according to the first embodiment. FIG. 3 is a conceptual diagram that illustrates the partial configuration of the analysis mechanism 2 according to the first embodiment. As shown in FIGS. 2 and 3, the analysis mechanism 2 according to the present embodiment is configured comprising a reaction disk 201, a constant temperature unit 202, a rack sampler 203, a reaction tube supplier 204, a standard sample storage 205, a standard sample dispensing probe 206, a subject sample dispensing arm 207, a subject sample dispensing probe 208, a first reagent storage 209, a first reagent dispensing probe 210, a second reagent storage 211, a second reagent dispensing arm 212, a second reagent dispensing probe 213, a reaction tube transportation arm 214, a photometric unit 215, a first agitation unit 216, and a second agitation unit 217.

The reaction disc 201 holds a plurality of reaction tubes 2011 that are circularly arranged. The reaction disk 201 transports the plurality of reaction tubes 2011 along a predetermined path. Specifically, during an analyzing operation of the liquid mixture of samples and reagents, the reaction disk 201 alternatively repeats rotating and stopping by the drive mechanism 4 in predetermined time intervals. The reaction tube 2011, for instance, is formed by glass, polypropylene (PP), or acryl.

A reaction tube placement position is set at a predetermined position on the reaction disk 201. The reaction tube placement position, for instance, is set at an intersection of a rotational trajectory, which is the transportation path of the reaction tube 2011 of the reaction tube transportation arm 214, and a rotational trajectory, which is the transportation path of the reaction tube 2011 of the reaction tube 201. The reaction tube 2011 transported by the reaction tube transportation arm 214 is placed on the reaction tube placement position.

The constant temperature unit 202 reserves a heat medium set to a predetermined temperature. The constant temperature unit 202 warms the liquid mixture contained in the reaction tube 2011 to a predetermined temperature and keeps it warm by immersing the reaction tube 2011 in the reserved heat medium.

The rack sampler 203 supports a sample rack 2031 in a movable manner, where the sample rack 2031 may hold a plurality of sample containers that contain samples requested for measurement. Samples such as blood requested for measurement are contained in the plurality of sample containers. In the examples shown in FIGS. 2 and 3, the sample rack 2031 each holding five sample containers in a row is illustrated.

On the rack sampler 203, a transportation area 2032 for transporting the sample rack 2031 is provided. That is to say, by using the transportation area 2032, the sample rack 2031 is transported from a feeding position where the sample rack 2031 is fed, to a collecting position where the measured sample rack 2031 is collected. In the transportation area 2032, a plurality of sample racks 2031 aligned in a longitudinal direction is moved in direction D1 by the drive mechanism 4.

Also, in the rack sampler 203 is provided a pull-in area 2033 that pulls in the sample rack 2031 from the transportation area 2032 and moves the sample containers held in the sample rack 2031 to a predetermined sample aspiration position. For instance, the sample aspiration position is set at an intersection of a motional trajectory of the subject sample dispensing probe 208 in a perpendicular direction, and a motional trajectory of an opening of the sample container held in the sample rack 2031 and supported by the rack sampler 203. In the pull-in area 2033, the transported sample rack 2031 is moved in direction D2 by the drive mechanism 4.

Likewise, in the rack sampler 203, a returning area 2034 in which the sample rack 2031 that holds the sample containers for which the samples are aspirated is returned to the transportation area 2032 is provided. In the returning area 2034, the sample rack 2031 is moved in direction D3 by the drive mechanism 4.

The reaction tube supplier 204 is provided in a vicinity of a periphery of the reaction disk 201. The reaction tube supplier 204, for instance, is configured by comprising a reaction tube container 2041 and a reaction tube supply rail 2042. The reaction tube container 2041, for instance, contains a plurality of empty reaction tubes 2011. The reaction tube container 2041 supplies the empty reaction tubes 2011 to the reaction tube supply rail 2042 by the control circuit 9. The reaction tube supply rail 2042, for instance, is inclinedly provided facing a reaction tube supplying position from the reaction tube container 2041. For this reason, the reaction tube 2011 slides on the reaction tube supply rail 2042 by gravity and moves to the reaction tube supplying position. The reaction tube supplying position, for instance, is set at an intersection of the rotational trajectory, which is the transportation path of the reaction tube 2011 of the reaction tube transportation arm 214, and a motional trajectory of the reaction tube 2011 on the reaction tube supply rail 2042.

The standard sample storage 205 holds and keeps cool the standard sample containers that contain standard samples used for each inspection item. The standard sample containers held in the standard sample storage 205, for instance, are disposable standard sample containers. The standard sample storage 205 is provided in the vicinity of the periphery of the reaction disk 201.

The standard sample dispensing probe 206 is provided on the standard sample storage 205. A standard sample dispensing position to dispense the standard sample to the reaction tube 2011 is set at a predetermined position below a tip of the standard sample dispensing probe 206. The standard sample dispensing position is set at an intersection of the rotational trajectory, which is the transportation path of the reaction tube 2011 of the reaction tube transportation arm 214, and a line segment passing through the standard sample dispensing probe 206 and vertically extending in an axial direction of the standard sample dispensing probe 206. The standard sample dispensing probe 206 dispenses the standard sample to the reaction tube 2011 arranged on the standard sample dispensing position under the control of the control circuit 9.

The subject sample dispensing arm 207 is provided between the reaction disk 201 and the rack sampler 203. The subject sample dispensing arm 207 is provided to be vertically movable in the perpendicular direction by the drive mechanism 4. The subject sample dispensing arm 207 holds the subject sample dispensing probe 208 on one end.

The subject sample dispensing probe 208 moves in the vertical direction following the vertical movement of the subject sample dispensing arm 207. On this movement trajectory, a subject sample aspiration position to aspirate the subject sample from the sample container held in the sample rack 2031 on the rack sampler 203 is set. Likewise, on the movement trajectory of the subject sample dispensing probe 208, a subject sample dispensing position to dispense the subject sample aspirated by the subject sample dispensing probe 208 to the reaction tube 2011 is set. The subject sample dispensing position is set at an intersection of the rotational trajectory, which is the transportation path of the reaction tube 2011 of the reaction tube transportation arm 214, and a line segment passing through the subject sample dispensing probe 208 and vertically extending along an axial direction of the subject sample dispensing probe 208.

The subject sample dispensing probe 208, driven by the drive mechanism 4, moves vertically at the subject sample aspiration position. The subject sample dispensing probe 208 also aspirates the subject sample from the sample container arranged on the subject sample aspiration position under the control of the control circuit 9. Furthermore, the subject sample dispensing probe 208 dispenses the aspirated subject sample to the reaction tube 2011 arranged on the subject sample dispensing position under the control of the control circuit 9.

Note that, in the description below, the standard sample dispensing probe 206 and the subject sample dispensing probe 208 may be simply referred to as the “sample dispensing probe” when referred to without distinction. Likewise, the subject sample dispensing position and the standard sample dispensing position may be simply referred to as the “sample dispensing position” when referred to without distinction.

The first reagent storage 209 holds and keeps cool a first reagent container that contains a first reagent used for each inspection item. The first reagent dispensing probe 210 is provided on the first reagent storage 209. The first reagent storage 209 is provided in the vicinity of the periphery of the reaction disk 201.

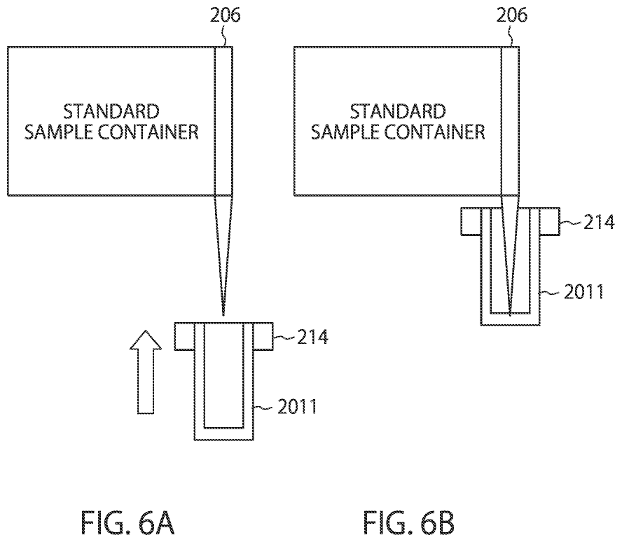

The first reagent dispensing probe 210 is provided on the first reagent storage 209. On a predetermined position below a tip of the first reagent dispensing probe 210, a first reagent dispensing position to dispense the first reagent to the reaction tube 2011 is set. The first reagent dispensing position is set at an intersection of the rotational trajectory, which is the transportation path of the reaction tube 2011 of the reaction tube transportation arm 214, and a line segment passing through the first reagent dispensing probe 210 and vertically extending along an axial direction of the first reagent dispensing probe 210. The first reagent dispensing probe 210 dispenses the first reagent to the reaction tube 2011 arranged on the first reagent dispensing position under the control of the control circuit 9. The first reagent container and the first reagent dispensing probe 210 may be configured in the same manner as the standard sample container and the standard sample dispensing probe 206 respectively (FIG. 6).

The second reagent storage 211 keeps cool a plurality of reagent containers that contain a second reagent that makes a pair with the first reagent of a two-reagent system. Although not shown in FIGS. 2 and 3, the second reagent storage 211 is covered by a detachable reagent cover. A reagent rack 2111 is provided to be rotatable on the second reagent storage 211.

The reagent rack 2111 circularly arranges and holds the plurality of reagent containers. The reagent rack 2111 is rotated by the drive mechanism 4. A reader (not shown) that reads reagent information from reagent labels attached on the reagent containers is also provided on the second reagent storage 211. The reagent information that is read is stored in the memory circuit 8. Note that the second reagent kept cool in the second reagent storage 211 may be a reagent with the same components and concentration as the first reagent kept cool in the first reagent storage 209.

A second reagent aspiration position is set on a predetermined position on the second reagent storage. The second reagent aspiration position, for instance, is set at an intersection of the rotational trajectory of the second reagent dispensing probe 213, and a motional trajectory of the opening of the reagent container circularly arranged on the reagent rack 2111.

The second reagent dispensing arm 212 is provided in the vicinity of the periphery of the reaction disk 201. The second reagent dispensing arm 212 is provided to be vertically movable in the perpendicular direction and rotatable in the horizontal direction by the drive mechanism 4. The second reagent dispensing arm 212 holds the second reagent dispensing probe 213 on one end.

The second reagent dispensing probe 213 rotates along an arc-shaped rotational trajectory, following the rotation of the second reagent dispensing arm 212. The second reagent aspiration position is set on this rotational trajectory. Likewise, on the rotational trajectory of the second reagent dispensing probe 213, the second reagent dispensing position to dispense the second reagent aspirated by the second reagent dispensing probe 213 to the reaction tube 2011 held on the reaction disk 201 is set. The second reagent dispensing position is set at an intersection of the rotational trajectory of the second reagent dispensing probe 213 and the rotational trajectory, which is the transportation path of the reaction tube 2011 of the reaction disk 201.

The second reagent dispensing probe 213 is driven by the drive mechanism 4 and moves vertically at the second reagent aspiration position or at the second reagent dispensing position on the rotational trajectory. The second reagent dispensing probe 213 also aspirates the second reagent from the reagent container right below the second reagent aspiration position under the control of the control circuit 9. The second reagent dispensing probe 213 also dispenses the aspirated second reagent to the reaction tube 2011 right below the second reagent dispensing position under the control of the control circuit 9.

Note that, in the description below, the first reagent dispensing probe 210 and the second reagent dispensing probe 213 may be simply referred to as the “reagent dispensing position” when referred to without distinction.

The reaction tube transportation arm 214 transports the reaction tube 2011 from the reaction tube supplier 204 to the reaction disk 201 by the drive mechanism 4. For instance, the reaction tube transportation arm 214 comprises a reaction tube holder to hold the reaction tube 2011 and a transportation arm to move the reaction tube holder rotationally and vertically. The reaction tube holder, for instance, is a gripper. The transportation arm is provided to be vertically movable in the perpendicular direction and rotatable in the horizontal direction by the drive mechanism 4. Note that the reaction tube transportation arm 214 is one example of a reaction tube transportation mechanism. Likewise, a number of the transportation arm that configures the reaction tube transportation arm 214 is arbitrary. For instance, the reaction tube transportation arm 214 may be configured by a plurality of transportation arms.

The reaction tube transportation arm 214 according to the present embodiment transports the reaction tube 2011 from the reaction tube supplier 204 to the reaction disk 201 such that the reaction tube holder of the reaction tube transportation arm 214 and the reaction tube 2011 held in the reaction tube holder pass through the transportation path. The transportation path of the reaction tube 2011 of the reaction tube transportation arm 214, for instance, is formed on the arc-shaped rotational trajectory following a rotation that centers on one end of the transportation arm. Note that the transportation path of the reaction tube 2011 of the reaction tube transportation arm 214 is arbitrary. For instance, the transportation path of the reaction tube 2011 of the reaction tube transportation arm 214 may be formed on an elliptical trajectory or may be formed on a transportation path without a particular shape.

The reaction tube supplying position, the standard sample dispensing position, the subject sample dispensing position, the first reagent dispensing position, and the reaction tube placement position is set on the transportation path of the reaction tube 2011 of the reaction tube transportation arm 214. The reaction tube transportation arm 214 transports the reaction tube 2011 held at the reaction tube supplying position to each position on the rotational trajectory, under the control of the control circuit 9. Note that the reaction tube transportation arm 214 may transport the reaction tube 2011 to the second reagent dispensing position.

The photometric unit 215 optically measures the liquid mixture of the sample and reagent dispensed in the reaction tube 2011. The photometric unit 215 has a light source and a photodetector. The photometric unit 215 irradiates light from the light source under the control of the control circuit 9. The irradiated light incidents from a first side wall of the reaction tube 2011 and emits from a second side wall opposite the first wall. The photometric unit 215 detects light emitted from the reaction tube 2011 by the photodetector.

Specifically, for instance, the photodetector is arranged on an optical axis of the light irradiated from the light source to the reaction tube 2011. The photodetector detects light that has penetrated the liquid mixture of the standard sample and reagent in the reaction tube 2011, and generates a standard data represented by absorbance, based on an intensity of the detected light. Likewise, the photodetector detects light that has penetrated the liquid mixture of the subject sample and the reagent in the reaction tube 2011, and generates a subject data represented by absorbance, based on the intensity of the detected light. The photometric unit 215 outputs the generated standard data and the subject data to the analysis circuit 3 as a measurement result.

The photodetector may be arranged off the optical axis of the light irradiated from the light source to the reaction tube 2011. In this case, the photodetector may detect light that has scattered in the liquid in the reaction tube 2011, and generate, based on the intensity of the scattered light, the standard data and the subject data.

The first agitation unit 216 is provided in the vicinity of the periphery of the reaction disk 201. The first agitation unit 216 has a first agitation arm 2161 and a first agitator provided on a tip of the first agitation arm. The first agitation unit 216, by the first agitator, agitates the liquid mixture of the standard sample and the first reagent contained in the reaction tube 2011 located at a first agitation position on the reaction disk 201. Likewise, the first agitation unit 216, by the first agitator, agitates the liquid mixture of the subject sample and the first reagent contained in the reaction tube 2011 located at the first agitation position on the reaction disk 201.

A second agitation unit 217 is provided in the vicinity of the periphery of the reaction disk 201. The second agitation unit 217 has a second agitation arm 2171 and a second agitator provided on a tip of the second agitation arm. The second agitation unit 217, by the second agitator, agitates the liquid mixture of the standard sample, the first reagent, and the second reagent contained in the reaction tube 2011 located at a second agitation position on the reaction disk 201. Likewise, the second agitation unit 217, by the second agitator, agitates the subject sample, the first reagent, and the second reagent contained in the reaction tube 2011 located at the second agitation position on the reaction disk 201.

Note that, in FIG. 2, the explanation is given for a case where the second reagent aspirated from the second reagent storage 211 is dispensed to the reaction tube 2011 by the second reagent dispensing arm 212 and the second reagent dispensing probe 213, but embodiments are not limited to this case. For instance, similar to a case of the first reagent storage 209, the second reagent dispensing probe 213 may be provided on the second reagent storage 211. That is to say, the second reagent dispensing probe 213 is provided on the second reagent storage 211 holding and keeping cool the second reagent container that contains the second reagent used for each inspection item. The second reagent dispensing position to dispense the second reagent to the reaction tube 2011 is set at a predetermined position below the tip of the second reagent dispensing probe 213. The second reagent dispensing probe 213, under the control of the control circuit 9, dispenses the second reagent to the reaction tube 2011 arranged on the second reagent dispensing position by the reaction tube transportation arm 214. For instance, the second reagent dispensing position is set at an intersection of the rotational trajectory, which is the transportation path of the reaction tube 2011 of the reaction tube transportation arm 214, and the line segment passing through the second reagent dispensing probe 213 and vertically extending along an axial direction of the second reagent dispensing probe 213. Note that, when providing the second reagent dispensing probe 213 to the second reagent storage 211, the automatic analyzing apparatus 1 may not comprise the second reagent dispensing arm 212.

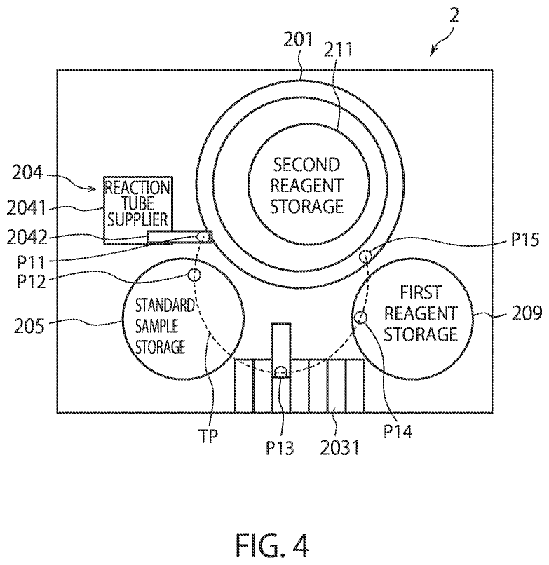

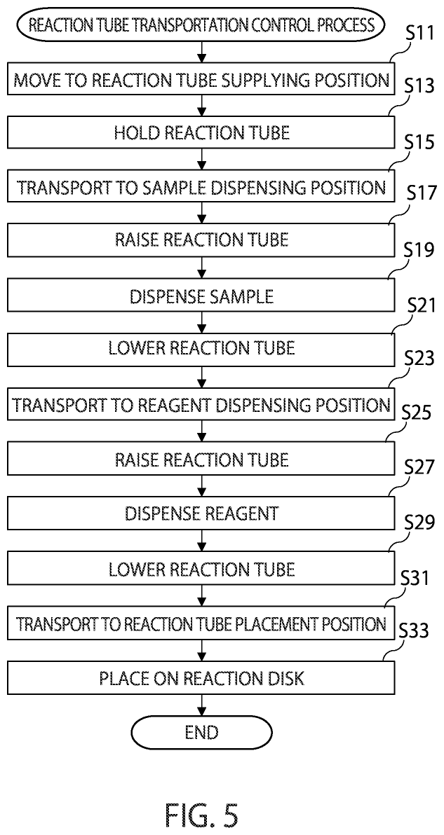

Next, referring to FIGS. 4 and 5, operational examples of the reaction tube transportation arm 214 by the automatic analyzing apparatus 1 according to the present embodiment will be described. FIG. 4 is a conceptual diagram that describes the transportation path, each position on the transportation path, and operational examples of the reaction tube 2011 of the reaction tube transportation arm 214 of the automatic analyzing apparatus 1 according to the present embodiment. FIG. 5 is a flowchart that describes a content of a reaction tube transportation control process executed in the automatic analyzing apparatus 1 according to the present embodiment. The reaction tube transportation control process is a process executed by the system control function 91 and the dispensing control function 92 of the control circuit 9.

As shown in FIG. 4, the reaction tube supplying position P11, the standard sample dispensing position P12, the subject sample dispensing position P13, the first reagent dispensing position P14, and the reaction tube placement position P15 are set on the transportation path TP of the reaction tube 2011 of the reaction tube transportation arm 214. Note that an arc-shaped dotted line shown in FIG. 4 indicates the transportation path TP of the reaction tube 2011 of the reaction tube transportation arm 214. Likewise, portions surrounded by circles shown in FIG. 4 indicate the reaction tube supplying position P11, the standard sample dispensing position P12, the subject sample dispensing position P13, the first reagent dispensing position P14, and the reaction tube placement position P15.

In FIG. 4, when dispensing the standard sample to the reaction tube 2011, the reaction tube transportation arm 214 first moves in the horizontal direction to hold the reaction tube 2011 at the reaction tube supplying position P11. Next, the reaction tube transportation arm 214 moves in the horizontal direction to transport the reaction tube 2011 held at the reaction tube supplying position P11 to the standard sample dispensing position P12. The reaction tube transportation arm 214 moves upward at the standard sample dispensing position P12 to bring a bottom portion of the reaction tube 2011 in contact with the tip of the standard sample dispensing probe 206. Then, the standard sample is dispensed to the reaction tube 2011. After the standard sample is dispensed to the reaction tube 2011, the reaction tube transportation arm 214 moves downward to pull out the reaction tube 2011 from the standard sample dispensing probe 206. Then, the reaction tube transportation arm 214 transports the reaction tube 2011 for which the standard sample is dispensed to the first reagent dispensing position P14 or the reaction tube placement position P15.

Likewise, in FIG. 4, when dispensing the subject sample to the reaction tube 2011, the reaction tube transportation arm 214 first moves in the horizontal direction to hold the reaction tube 2011 at the reaction tube supplying position P11. Next, the reaction tube transportation arm 214 moves in the horizontal direction to transport the reaction tube 2011 held at the reaction tube supplying position P11 to the subject sample dispensing position P13. The reaction tube transportation arm 214 moves upward at the subject sample dispensing position P13 to bring the bottom portion of the reaction tube 2011 in contact with the tip of the subject sample dispensing probe 208. Then, the subject sample is dispensed to the reaction tube 2011. After the subject sample is dispensed to the reaction tube 2011, the reaction tube transportation arm 214 moves downward to pull out the reaction tube 2011 from the subject sample dispensing probe 208. Then, the reaction tube transportation arm 214 transports the reaction tube 2011 for which the subject sample is dispensed to the first reagent dispensing position P14 or the reaction tube placement position P15.

Likewise, in FIG. 4, when dispensing the first reagent to the reaction tube 2011, the reaction tube transportation arm 214 first moves in the horizontal direction to transport the reaction tube 2011 held at the reaction tube supplying position P11, or the reaction tube 2011 for which the sample has been dispensed, to the first reagent dispensing position P14. Next, the reaction tube transportation arm 214 moves upward at the first reagent dispensing position P14 to arrange the reaction tube 2011 at a position where the tip of the first reagent dispensing probe 210 is in a vicinity of the liquid surface of the liquid mixture of the sample and the first reagent in the reaction tube 2011 when the first reagent is completely dispensed. Then, the first reagent is dispensed to the reaction tube 2011. After the first reagent is dispensed to the reaction tube 2011, the reaction tube transportation arm 214 moves downward to pull out the reaction tube 2011 from the subject sample dispensing probe 208. The reaction tube transportation arm 214 transports the reaction tube 2011 for which the first reagent is dispensed, to the reaction tube placement position P15.

Likewise, in FIG. 4, when placing the reaction tube 2011 at the reaction disk 201, the reaction tube transportation arm 214 moves in the horizontal direction to transport the reaction tube 2011 for which the sample or the reagent has been dispensed, to the reaction tube placement position P15. Then, the reaction tube transportation arm 214 moves downward at the reaction tube placement position P15 to place the reaction tube 2011 that is held at the reaction disk 201.

A control about the reaction tube transportation arm 214 will be described using the flowchart of FIG. 5. When the reaction tube transportation control process according to the present embodiment shown in FIG. 5 begins, the system control function 91 of the control circuit 9 controls the reaction tube transportation arm 214 to move the reaction tube holder to the reaction tube supplying position P11 (Step S11). That is to say, the system control function 91 rotates the transportation arm of the reaction tube transportation arm 214 by the drive mechanism 4 and moves the reaction tube holder to the reaction tube supplying position P11. Next, the system control function 91 causes the reaction tube holder to hold the reaction tube 2011 (Step S13). That is to say, the system control function 91 controls the reaction tube holder of the reaction tube transportation arm 214 to hold the reaction tube 2011 at the reaction tube supplying position P11.

Next, the system control function 91 of the control circuit 9 controls the reaction tube transportation arm 214 to transport the reaction tube 2011 to the sample dispensing position (Step S15). Specifically, when dispensing the standard sample, the system control function 91 controls the drive mechanism 4 to rotate the transportation arm of the reaction tube transportation arm 214 and transport the reaction tube 2011 to the standard sample dispensing position P12 among the sample dispensing positions. Likewise, when dispensing the subject sample, the system control function 91 controls the drive mechanism 4 to rotate the transportation arm of the reaction tube transportation arm 214 and transport the reaction tube 2011 to the subject sample dispensing position P13 among the sample dispensing positions.

Next, the system control function 91 of the control circuit 9 controls the reaction tube transportation arm 214 to raise the reaction tube 2011 at the sample dispensing position (Step S17). Specifically, the system control function 91 controls the drive mechanism 4 to raise the transportation arm of the reaction tube transportation arm 214 at the standard sample dispensing position P12 or the subject sample dispensing position P13 and raise the reaction tube 2011.

FIG. 6 is a schematic diagram that schematically illustrates arrangements of the reaction tube 2011 and the standard sample dispensing probe 206 arranged on the standard sample dispensing position P12 among the sample dispensing positions in the automatic analyzing apparatus 1 according to the present embodiment. As shown in FIG. 6A, at the standard sample dispensing position P12, the system control function 91 controls the reaction tube transportation arm 214 to start raising the reaction tube 2011. Then, as shown in FIG. 6B, the system control function 91 controls the reaction tube transportation arm 214 to raise the reaction tube 2011 and arrange the reaction tube 2011 such that the bottom portion of the reaction tube 2011 is brought in contact with the tip of the standard sample dispensing probe 206. As such, the system control function 91 controls the reaction tube transportation arm 214 and the dispensing control function 92 to arrange such that the bottom portion of the reaction tube 2011 is brought in contact with the tip of the standard sample dispensing probe 206 and dispense the standard sample. Therefore, the automatic analyzing apparatus 1 may dispense an appropriate amount of the standard sample to the reaction tube 2011.

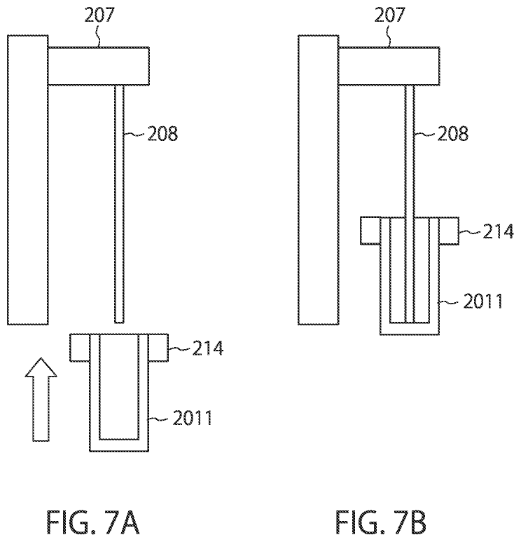

FIG. 7 is a schematic diagram that schematically illustrates arrangements of the reaction tube 2011 and the subject sample dispensing probe 208 arranged on the subject sample dispensing position P13 among the sample dispensing positions in the automatic analyzing apparatus 1 according to the present embodiment. As shown in FIG. 7A, at the subject sample dispensing position P13, the system control function 91 controls the reaction tube transportation arm 214 to start raising the reaction tube 2011. Then, as shown in FIG. 7B, the system control function 91 controls the reaction tube transportation arm 214 to raise the reaction tube 2011 and arrange the reaction tube 2011 such that the bottom portion of the reaction tube 2011 is brought in contact with the tip of the subject sample dispensing probe 208. As such, the system control function 91 controls the reaction tube transportation arm 214 and the dispensing control function 92 to arrange such that the bottom portion of the reaction tube 2011 is brought in contact with the tip of the subject sample dispensing probe 208, and dispense the subject sample. Therefore, the automatic analyzing apparatus 1 may dispense an appropriate amount of the subject sample to the reaction tube 2011.

Note that the arrangement of the tip of the sample dispensing probe relative to the bottom portion of the reaction tube 2011 arranged on the sample dispensing position is arbitrary. For instance, the system control function 91, instead of controlling the reaction tube transportation arm 214 to raise the reaction tube 2011 such that the bottom portion of the reaction tube 2011 is brought in contact with the tip of the sample dispensing probe, may control the reaction tube transportation arm 214 to raise the reaction tube 2011 such that the bottom portion of the reaction tube 2011 is located in the vicinity of the tip of the sample dispensing probe. Here, to locate in the vicinity of the tip of the sample dispensing probe, for instance, is to locate the bottom portion of the reaction tube 2011 at a position separated by a predetermined distance below from the tip of the sample dispensing probe.

Next, the dispensing control function 92 of the control circuit 9 controls the sample dispensing probe to dispense the sample to the reaction tube 2011 (Step S19). A sample amount to dispense to the reaction tube 2011 is determined based on the inspection items by the system control function 91 or the dispensing control function 92.

After dispensing the sample to the reaction tube 2011, the system control function 91 of the control circuit 9 controls the reaction tube transportation arm 214 to lower the reaction tube 2011 (Step S21). Specifically, the system control function 91 controls the drive mechanism 4 to lower the transportation arm of the reaction tube transportation arm 214 and lower the reaction tube 2011 so as to pull out the reaction tube 2011 from the sample dispensing probe.

Note that, when dispensing the subject sample to the reaction tube 2011 from Step S15 to Step S19, instead of the system control function 91 controlling the reaction tube transportation arm 214 to raise the reaction tube 2011, the system control function 91 may also control the subject sample dispensing arm 207 to lower the subject sample dispensing probe 208.

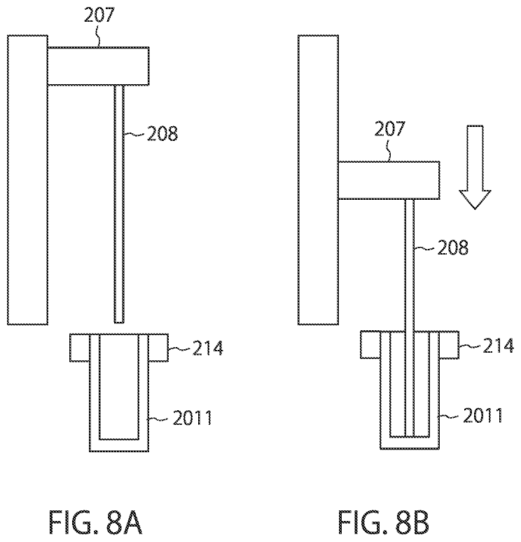

FIG. 8 is a schematic diagram that schematically illustrates arrangements of the reaction tube 2011 and the subject sample dispensing probe 208 arranged on the subject sample dispensing position P13 in the automatic analyzing apparatus 1 according to the first embodiment, and is a figure corresponding to FIG. 7. As shown in FIGS. 8A and 8B, the system control function 91 controls the subject sample dispensing arm 207, for the reaction tube 2011 arranged on the subject sample dispensing position P13, to lower the subject sample dispensing probe 208 such that the tip of the subject sample dispensing probe 208 is brought in contact with the bottom portion of the reaction tube 2011. Then, the dispensing control function 92 controls the subject sample dispensing probe 208 to dispense the subject sample to the reaction tube 2011. After dispensing the subject sample to the reaction tube 2011, the system control function 91 controls the drive mechanism 4 to raise the subject sample dispensing probe 208 to raise the subject sample dispensing probe 208 so as to pull out the sample dispensing probe 208 from the reaction tube 2011. As such, the system control function 91 controls the reaction tube transportation arm 214 and the dispensing control function 92 to arrange such that the tip of the subject sample dispensing probe 208 is brought in contact with the bottom portion of the reaction tube 2011, and dispense the subject sample. Therefore, the automatic analyzing apparatus 1 may dispense the appropriate amount of the subject sample to the reaction tube 2011.

Note that the arrangement of the bottom portion of the reaction tube 2011 relative to the tip of the subject sample dispensing probe 208 arranged on the sample dispensing position is arbitrary. For instance, the system control function 91, instead of controlling the reaction tube transportation arm 214 to lower the tip of the subject sample dispensing probe 208 such that the tip of the subject sample dispensing probe 208 is brought in contact with the bottom portion of the reaction tube 2011, may control the reaction tube transportation arm 214 to lower the tip of the subject sample dispensing probe 208 such that the tip of the subject sample dispensing probe 208 is located in the vicinity of the bottom portion of the reaction tube 2011. Here, to locate in the vicinity of the tip of the subject sample dispensing probe 208, for instance, is to arrange the tip of the subject sample dispensing probe 208 at a position separated by a predetermined distance above from the bottom portion of the reaction tube 2011.

Next, the system control function 91 of the control circuit 9 controls the reaction tube transportation arm 214 to transport the reaction tube 2011 to the reagent dispensing position (Step S23). Specifically, when dispensing the first reagent among the reagents, the system control function 91 controls the drive mechanism 4 to rotate the transportation arm of the reaction tube transportation arm 214 and transport the reaction tube 2011 to the first reagent dispensing position P14 among the sample dispensing positions.

Next, the system control function 91 of the control circuit 9 controls the reaction tube transportation arm 214 to raise the reaction tube 2011 at the reagent dispensing position (Step S25). Specifically, when dispensing the first reagent among the reagents, the system control function 91, before starting to dispense the first reagent at the first reagent dispensing position P14 among the sample dispensing positions, controls the drive mechanism 4 to raise the transportation arm of the reaction tube transportation arm 214 and raise the reaction tube 2011.

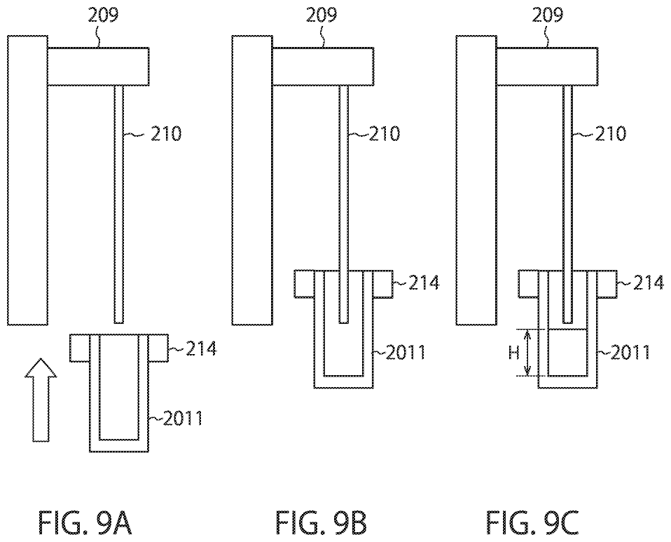

FIG. 9 is a schematic diagram that schematically illustrates arrangement of the reaction tube 2011 and the first reagent dispensing probe 210 arranged on the first reagent dispensing position P14 among the sample dispensing positions in the automatic analyzing apparatus 1 according to the present embodiment. As shown in FIG. 9A, before starting to dispense the first reagent, at the first reagent dispensing position P14, the system control function 91 controls the reaction tube transportation arm 214 to raise the reaction tube 2011 so as to arrange the tip of the first reagent dispensing probe 210 at a position in the vicinity of the liquid surface of the liquid mixture of the sample and the first reagent when the first reagent is completely dispensed.

Then, as shown in FIG. 9B, the system control function 91 of the control circuit 9, when the tip of the first reagent dispensing probe 210 is arranged on a position in the vicinity of the liquid mixture of the sample and the first reagent when the first reagent is completely dispensed, controls the reaction tube transportation arm 214 to stop raising the reaction tube 2011. Here, the position in the vicinity of the surface of the liquid mixture of the sample and the first reagent when the first reagent is completely dispensed is, as shown in FIG. 9C, a position above a height H of the liquid surface of the liquid mixture based on the sample amount and the reagent amount dispensed in the reaction tube 2011 preset for each inspection item, and is a position in the vicinity of the liquid surface of the liquid mixture.

As such, since the system control function 91 controls the reaction tube transportation arm 214 to arrange the tip of the first reagent dispensing probe 210 in the position in the vicinity of the liquid surface of the liquid mixture of the sample and the first reagent when the first reagent is completely dispensed, the dispensing control function 92 may bring the liquid surface of the liquid mixture close with the tip of the first reagent dispensing probe 210 and dispense. As a result, a splattering of reagents may be reduced.

Next, the dispensing control function 92 of the control circuit 9 controls the first reagent dispensing probe 210 to dispense the first reagent to the reaction tube 2011 (Step S27). The amount of the first reagent to dispense to the reaction tube 2011 is determined based on the inspection items by the system control function 91 or the dispensing control function 92.

After dispensing the first reagent to the reaction tube 2011, the system control function 91 of the control circuit 9 controls the reaction tube transportation arm 214 to lower the reaction tube 2011 (Step S29). Specifically, the system control function 91 controls the drive mechanism 4 to lower the transportation arm of the reaction tube transportation arm 214 by the drive mechanism 4 and lower the reaction tube 2011 so as to pull out the reaction tube 2011 from the first reagent dispensing probe 210.

Next, the system control function 91 of the control circuit 9 controls the reaction tube transportation arm 214 to transport the reaction tube 2011 to the reaction tube placement position P15 of the reaction disk 201 (Step S31). Specifically, the system control function 91 controls the drive mechanism 4 to rotate the transportation arm of the reaction tube transportation arm 214 and transport the reaction tube 2011 to the reaction tube placement position P15 in FIG. 4.

Next, the system control function 91 of the control circuit 9 controls the reaction tube transportation arm 214 to place the reaction tube 2011 on the reaction disk 201 (Step S33). That is to say, the system control function 91 controls the reaction tube holder of the reaction tube transportation arm 214 to release a hold of the reaction tube 2011, insert the reaction tube 2011 to the reaction disk 201, and place the reaction tube 2011 on the reaction disk 201. By Step S33, the reaction tube transportation control process according to the present embodiment is ended.

As described above, according to the automatic analyzing apparatus 1 in the present embodiment, since the reaction tube transportation arm 214 transports the reaction tube 2011 to the reaction tube supplying position P11, the standard sample dispensing position P12, the subject sample dispensing position P13, the first reagent dispensing position P14, and the reaction tube placement position P15 on the transportation path TP, there is no need to provide the moving mechanism in the horizontal direction to the sample dispensing probe. As a result, the number of parts of the automatic analyzing apparatus 1 may be reduced, and the automatic analyzing apparatus 1 may be miniaturized.

Furthermore, since the automatic analyzing apparatus 1 controls the reaction tube transportation arm 214 to raise the reaction tube 2011 at the standard sample dispensing position P12 and the first reagent dispensing position P14, there is no need to provide the moving mechanism in the vertical direction to the standard sample dispensing probe 206. As a result, the number of parts of the automatic analyzing apparatus 1 may be reduced, and the automatic analyzing apparatus 1 may be miniaturized.

Note that, in the present embodiment described above, the second reagent dispensing probe 213 rotates along an arc-shaped rotational movement following the rotation of the second reagent dispensing arm 212 and, by moving to the second reagent dispensing position set on this rotational trajectory, dispense the second reagent to the reaction tube 2011 transported to the second reagent dispensing position by the reaction disk 201, but embodiments are not limited to the second reagent dispensing probe 213 moving to the second reagent dispensing position and dispensing the second reagent to the reaction tube 2011 transported to the second reagent dispensing position by the reaction disk 201. That is to say, the system control function 91 may control the reaction tube transportation arm 214 and the dispensing control function 92 to raise the reaction tube 2011 at the second reagent dispensing position and dispense the second reagent.

That is to say, the system control function 91 controls the reaction tube transportation arm 214 to hold the reaction tube 2011, for which the sample and the first reagent on the reaction disk 201 has been dispensed, by the reaction tube holder of the reaction tube transportation arm 214 at the reaction tube placement position P15. Next, the system control function 91 controls the reaction tube transportation arm 214 to move the reaction tube transportation arm 214 upward, and pull out the reaction tube 2011 from the reaction disk 201. Next, the system control function 91 controls the reaction tube transportation arm 214 to transport the reaction tube 2011 to the second reagent dispensing position. Next, the system control function 91 controls the reaction tube transportation arm 214 before starting to dispense the second reagent, to raise the reaction tube 2011 such that the tip of the second reagent dispensing probe 213 at the second reagent dispensing position is arranged at a position in the vicinity of the liquid surface of the liquid mixture of the sample, the first reagent, and the second reagent in the reaction tube 2011 when the second reagent is completely dispensed. Then, the dispensing control function 92 controls the second reagent dispensing probe 213 to dispenses the second reagent to the reaction tube 2011. After the second reagent is dispensed to the reaction tube 2011, the system control function 91 controls the reaction tube transportation arm 214 to pull out the reaction tube 2011 from the second reagent dispensing probe 213. The system control function 91 controls the reaction tube transportation arm 214 to transport the reaction tube 2011 for which the sample, the first reagent, and the second reagent are dispensed to the reaction tube placement position P15, to insert the reaction tube 2011 to the reaction disk 201, and to place the reaction tube 2011 on the reaction disk 201.

### Second Embodiment

In the first embodiment described above, the reaction tube supplying position P11 and the standard sample dispensing position P12 provided on the transportation path TP of the reaction tube transportation arm 214 are respectively provided on different positions on the transportation path TP of the reaction tube transportation arm 214, but the reaction tube supplying position P11 and the standard sample dispensing position P12 are not necessarily limited to be provided on different positions. Thus, in a second embodiment, the automatic analyzing apparatus 1 for which the reaction tube supplying position P11 and the standard sample dispensing position P12 are in the same position will be described. The detailed description different from a description of the first embodiment described above will be made below. Note that, since the configuration of the automatic analyzing apparatus 1 according to the present embodiment is the same as the configuration of the automatic analyzing apparatus 1 of FIG. 1, the description will be omitted.

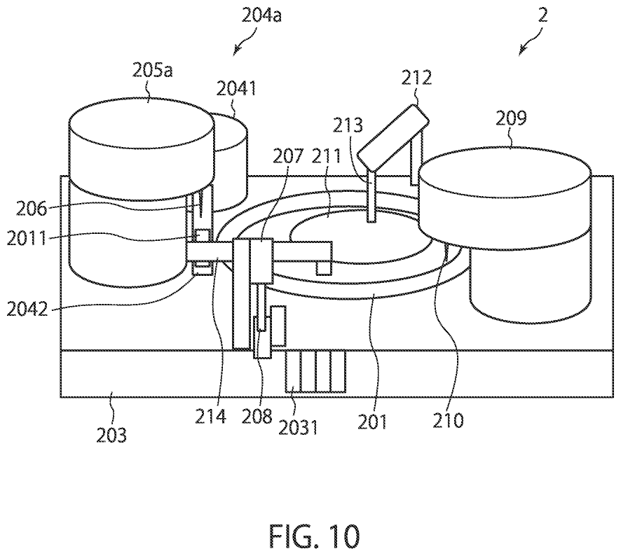

FIG. 10 is a conceptual diagram that illustrates a partial configuration of the analysis mechanism 2 according to the second embodiment, and is a figure corresponding to FIG. 3 according to the first embodiment described above. As shown in FIGS. 2 and 10, the analysis mechanism 2 according to the present embodiment is configured comprising the reaction disk 201, the constant temperature unit 202, the rack sampler 203, a reaction tube supplier 204a, a standard sample storage 205a, a standard sample dispensing probe 206a, the subject sample dispensing arm 207, the subject sample dispensing probe 208, the first reagent storage 209, the first reagent dispensing probe 210, the second reagent storage 211, the second reagent dispensing arm 212, the second reagent dispensing probe 213, the reaction tube transportation arm 214, the photometric unit 215, the first agitation unit 216, and the second agitation unit 217. Note that, since the exemplary configuration of the analysis mechanism 2 other than the configuration of the reaction tube supplier 204a, the standard sample storage 205a, and the standard sample dispensing probe 206a is the same as the configuration of the first embodiment, description will be omitted.

The reaction tube supplier 204a is provided in the vicinity of the periphery of the reaction disk 201. The reaction tube supplier 204a, for instance, is configured by comprising the reaction tube container 2041 and the reaction tube supply rail 2042. The reaction tube container 2041, for instance, contains the plurality of empty reaction tubes 2011. The reaction tube container 2041 supplies the empty reaction tubes 2011 to the reaction tube supply rail 2042 by the control circuit 9. The reaction tube supply rail 2042, for instance, is inclinedly provided facing the reaction tube supplying position from the reaction tube container 2041. For this reason, the reaction tube 2011 slides on the reaction tube supply rail 2042 by gravity and moves to the reaction tube supplying position. The reaction tube supplying position according to the second embodiment, for instance, is set at an intersection of the rotational trajectory, which is the transportation path of the reaction tube 2011 of the reaction tube transportation arm 214, the motional trajectory of the reaction tube 2011 on the reaction tube supply rail 2042, and the line segment passing through the standard sample dispensing probe 206a and vertically extending along an axial direction of the standard sample dispensing probe 206a.

The standard sample storage 205a holds and keeps cool the standard sample containers that contain the standard sample used for each inspection item. The standard sample containers held in the standard sample storage 205a, for instance, are disposable standard sample containers. The standard sample storage 205a is provided such that the standard sample dispensing probe 206a is arranged above the reaction tube supplying position of the reaction tube supplier 204a.

The standard sample dispensing probe 206a is provided on the standard sample storage 205a. A standard sample dispensing position to dispense the standard sample to the reaction tube 2011 is set at a predetermined position below a tip of the standard sample dispensing probe 206a. The standard sample dispensing position is set at an intersection of the rotational trajectory, which is the transportation path of the reaction tube 2011 of the reaction tube transportation arm 214, the line segment passing through the standard sample dispensing probe 206a and vertically extending along an axial direction of the standard sample dispensing probe 206a, and the motional trajectory of the reaction tube 2011 on the reaction tube supply rail 2042. The standard sample dispensing probe 206a dispenses the standard sample to the reaction tube 2011 located on the standard sample dispensing position under the control of the control circuit 9. That is to say, in the present embodiment, the reaction tube supplying position and the standard sample dispensing position are the same positions. Note that, the same position includes the reaction tube supplying position and the standard sample dispensing position being substantially the same positions.

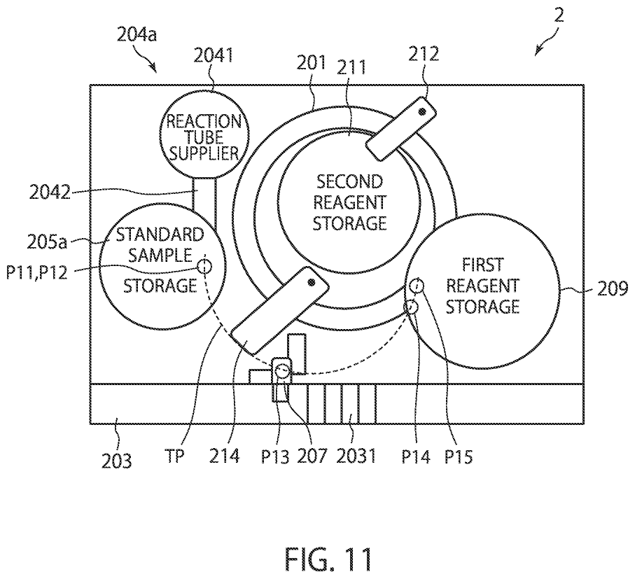

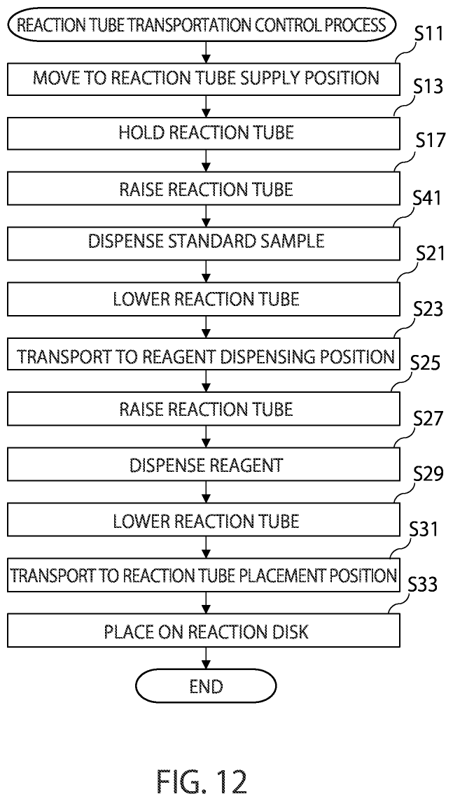

Next, referring to FIGS. 11 and 12, operational examples of the reaction tube transportation arm 214 when dispensing the standard sample by the automatic analyzing apparatus 1 according to the present embodiment will be described. FIG. 11 is a conceptual diagram that describes a transportation path, each position on the transportation path of the reaction tube 2011, and operational examples of the reaction tube 2011 of the reaction tube transportation arm 214 of the automatic analyzing apparatus 1 according to the second embodiment, and is a figure corresponding to FIG. 4 of the first embodiment described above. FIG. 12 is a flowchart that describes a content of the reaction tube transportation control process when dispensing the standard sample, executed in the automatic analyzing apparatus 1 according to the second embodiment, and is a figure corresponding to FIG. 5 of the first embodiment described above. The reaction tube transportation control process is a process executed by the system control function 91 and the dispensing control function 92 of the control circuit 9. Note that, since the content of the reaction tube transportation control process when dispensing the subject sample is the same as the content of the reaction tube transportation control process according to the first embodiment described above, the description will be omitted.

As shown in FIG. 11, the reaction tube supplying position P11, the standard sample dispensing position P12, the subject sample dispensing position P13, the first reagent dispensing position P14, and the reaction tube placement position P15 are set on the rotational trajectory of the transportation path TP of the reaction tube 2011 of the reaction tube transportation arm 214. Note that an arc-shaped dotted line shown in FIG. 4 indicates the rotational trajectory of the transportation path TP of the reaction tube 2011 of the reaction tube transportation arm 214. Likewise, the black circles shown in FIG. 11 indicates a center of rotation of the transportation arm and the second reagent dispensing arm. Furthermore, portions surrounded by circles shown in FIG. 11 indicate the reaction tube supplying position P11, the standard sample dispensing position P12, the subject sample dispensing position P13, the first reagent dispensing position P14, and the reaction tube placement position P15. Note that the first reagent dispensing position P14 and the reaction tube placement position P15 may be configured to be same positions.

As shown in FIG. 11, when dispensing the standard sample to the reaction tube 2011, first, the reaction tube transportation arm 214 moves in the horizontal direction and holds the reaction tube 2011 at the reaction tube supplying position P11. In the automatic analyzing apparatus 1 according to the present embodiment, the reaction tube supplying position P11 and the standard sample dispensing position P12 are the same positions. For this reason, the reaction tube transportation arm 214 does not move in the horizontal direction, but moves upward at the reaction tube supplying position P11, which is the standard sample dispensing position P12, such that the bottom portion of the reaction tube 2011 is brought in contact with the tip of the standard sample dispensing probe 206a. Then, the standard sample is dispensed to the reaction tube 2011. After the standard sample has been dispensed to the reaction tube 2011, the reaction tube transportation arm 214 moves downward and pulls out the reaction tube 2011 from the standard sample dispensing probe 206a. Then, the reaction tube transportation arm 214 transports the reaction tube 2011 for which the standard sample has been dispensed, to the first reagent dispensing position P14 or the reaction tube placement position P15. Note that, since operational examples of the reaction tube transportation arm 214 when dispensing the subject sample, when dispensing the first reagent, and when placing the reaction tube 2011 on the reaction disk 201, are the same as operational examples of the reaction tube transportation arm 214 according to the first embodiment, the description will be omitted.

Next, the flowchart of FIG. 12 will be used to describe about the control of the reaction tube transportation arm 214 when dispensing the standard sample according to the present embodiment. In the reaction tube transportation control process according to the present embodiment shown in FIG. 12, the process until Step S11 and Step S13 is the same as the reaction tube transportation control process of the first embodiment described above. Then, after Step S13, the system control function 91 of the control circuit 9 according to the present embodiment controls the reaction tube transportation arm 214 to raise the reaction tube 2011 at the reaction tube supplying position P11 without transporting the reaction tube 2011 (Step S17). Specifically, in the automatic analyzing apparatus 1 according to the present embodiment, the reaction tube supplying position P11 and the standard sample dispensing position P12 are the same positions. That is to say, the position for which the reaction tube holder held the reaction tube 2011 at the reaction tube supplying position P11 is the standard sample dispensing position P12. Accordingly, in the automatic analyzing apparatus 1 according to the present embodiment, the system control function 91, without transporting the reaction tube 2011 to the standard sample dispensing position P12, controls the drive mechanism 4 to raise the transportation arm of the reaction tube transportation arm 214 at the reaction tube supplying position P11 which is the standard sample dispensing position P12, and raise the reaction tube 2011.

Next, the dispensing control function 92 of the control circuit 9 controls the standard sample dispensing probe 206 to dispense the standard sample from the tip of the standard sample dispensing probe 206 to the reaction tube 2011 (Step S41). The amount of standard sample dispensed to the reaction tube 2011 is determined based on the inspection items by the system control function 91 or the dispensing control function 92. The process of Step S21 through Step S33 after Step S41 is the same as the reaction tube transportation control process of the first embodiment described above, and after the reaction tube 2011 is placed on the reaction disk 201 at Step S33, the reaction tube transportation control process of the automatic analyzing apparatus 1 according to the present embodiment is ended.

As described above, according to the automatic analyzing apparatus 1 in the present embodiment, since the reaction tube transportation arm 214 transports the reaction tube 2011 to the reaction tube supplying position P11, the standard sample dispensing position P12, the subject sample dispensing position P13, the first reagent dispensing position P14, and the reaction tube placement position P15 on the transportation path TP same as in the first embodiment described above, there is no need to provide the moving mechanism in the horizontal direction to the sample dispensing probe, and the number of parts of the automatic analyzing apparatus 1 may be reduced. Likewise, in the automatic analyzing apparatus 1 according to the present embodiment, since the reaction tube supplying position P11 and the standard sample dispensing position P12 are the same positions, a transportation distance of the reaction tube 2011 of the reaction tube transportation arm 214 may be shortened. As a result, the automatic analyzing apparatus 1 may be miniaturized.

### Third Embodiment

In the first embodiment and the second embodiment described above, the reaction tube supplying position P11 provided on the transportation path TP of the reaction tube transportation arm 214 and the subject sample dispensing position P13 are respectively provided on different positions, but the reaction tube supplying position P11 and the subject sample dispensing position P13 are not necessarily limited to be provided on in different positions. In a third embodiment, the automatic analyzing apparatus 1 for which the reaction tube supplying position P11 and the subject sample dispensing position P13 are the same position will be described. The detailed description different from a description of the first embodiment described above will be made below. Note that, since the configuration of the automatic analyzing apparatus 1 according to the present embodiment is the same as the configuration of the automatic analyzing apparatus 1 of FIG. 1, the description will be omitted.

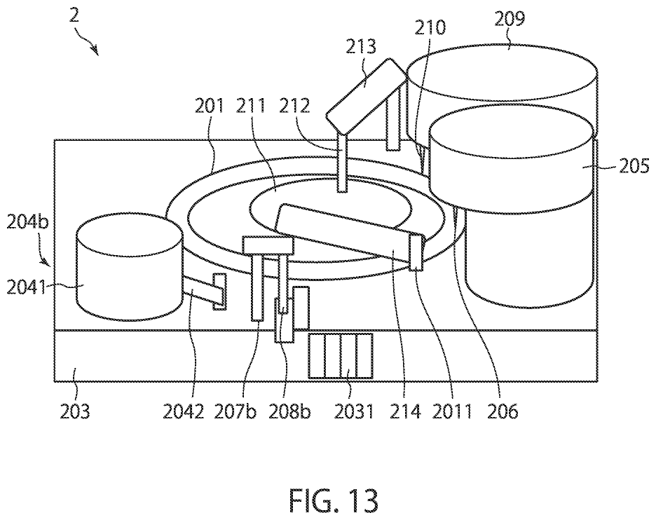

FIG. 13 is a conceptual diagram that illustrates a partial configuration of the analysis mechanism 2 according to the present embodiment, and is a figure corresponding to FIG. 3 according to the first embodiment described above. As shown in FIGS. 2 and 13, the analysis mechanism 2 according to the present embodiment is configured comprising the reaction disk 201, the constant temperature unit 202, the rack sampler 203, a reaction tube supplier 204b, the standard sample storage 205, the standard sample dispensing probe 206, a subject sample dispensing arm 207b, a subject sample dispensing probe 208b, the first reagent storage 209, the first reagent dispensing probe 210, the second reagent storage 211, the second reagent dispensing arm 212, the second reagent dispensing probe 213, the reaction tube transportation arm 214, the photometric unit 215, the first agitation unit 216, and the second agitation unit 217. Note that, since the exemplary configuration of the analysis mechanism other than the reaction tube supplier 204b, the subject sample dispensing arm 207b, and the subject sample dispensing probe 208b according to the third embodiment is the same as the configuration of the first embodiment, description will be omitted.

The reaction tube supplier 204b is provided in the vicinity of the periphery of the reaction disk 201. The reaction tube supplier 204b, for instance, is configured by comprising the reaction tube container 2041 and the reaction tube supply rail 2042. The reaction tube container 2041, for instance, contains the plurality of empty reaction tube 2011. The reaction tube container 2041 supplies the empty reaction tubes 2011 to the reaction tube supply rail 2042 by the control circuit 9. The reaction tube supply rail 2042, for instance, is inclinedly provided facing the reaction tube supplying position from the reaction tube container 2041. For this reason, the reaction tube 2011 slides on the reaction tube supply rail 2042 by gravity and moves to the reaction tube supplying position. The reaction tube supplying position according to the third embodiment, for instance, is set at an intersection of the rotational trajectory, which is the transportation path of the reaction tube 2011 of the reaction tube transportation arm 214, the motional trajectory of the reaction tube 2011 on the reaction tube supply rail 2042, and the rotational trajectory of the subject sample dispensing probe 208b.

The subject sample dispensing arm 207b is provided between the rack sampler 203 and the reaction tube supplier 204. The subject sample dispensing arm 207b is provided to be vertically movable in the perpendicular direction and rotatable in the horizontal direction by the drive mechanism 4. The subject sample dispensing arm 207b holds the subject sample dispensing probe 208b on one end.

The subject sample dispensing probe 208b rotates along the arc-shaped rotational trajectory following the rotation of the subject sample dispensing arm 207b. On this rotational trajectory, the subject sample aspiration position to aspirate the sample from the sample containers held at the sample rack 2031 on the rack sampler 203 is set. Likewise, on the rotational trajectory of the subject sample dispensing probe 208b, the subject sample dispensing position to dispense the subject sample aspirated by the subject sample dispensing probe 208b to the reaction tube 2011 is set. The subject sample dispensing position, for instance, is set at an intersection of the rotational trajectory of the subject sample dispensing probe 208b, the rotational trajectory of the transportation path of the reaction tube 2011 of the reaction tube transportation arm 214, and the motional trajectory of the reaction tube 2011 of the reaction tube supply rail 2042. That is to say, according to the present embodiment, the reaction tube supplying position and the subject sample dispensing position are the same positions. Note that, the same position includes the reaction tube supplying position and the subject sample dispensing position being substantially the same positions.

The subject sample dispensing probe 208b is driven by the drive mechanism 4, and moves in the vertical direction at the subject sample aspiration position or the subject sample dispensing position right above the opening of the sample container held at the rack sampler 203. Also, the subject sample dispensing probe 208b aspirates the sample from the sample containers on the subject sample aspiration position under the control of the control circuit 9. Likewise, the subject sample dispensing probe 208b dispenses the aspirated sample to the reaction tube 2011 arranged on the reaction tube supplying position which is the subject sample dispensing position under the control of the control circuit 9.

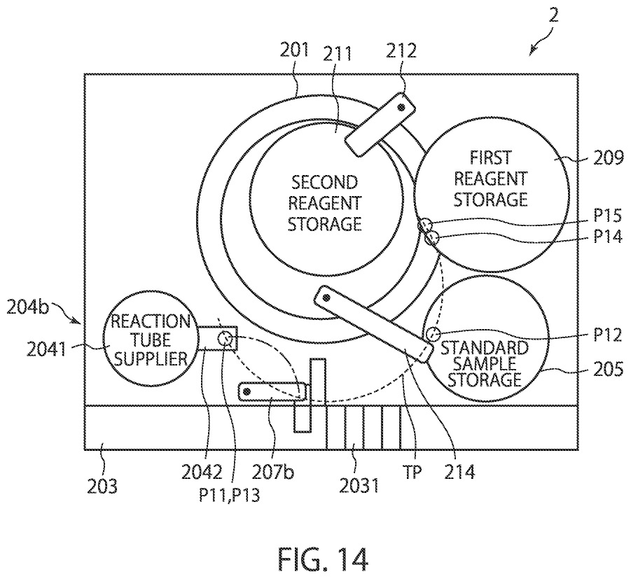

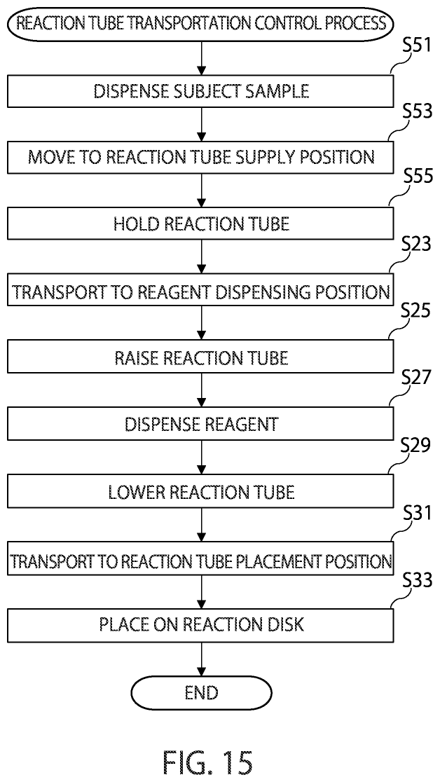

Next, referring to FIGS. 14 and 15, operational examples of the reaction tube transportation arm 214 when dispensing the subject sample by the automatic analyzing apparatus 1 according to the present embodiment will be described. FIG. 14 is a conceptual diagram that describes the transportation path, each position on the transportation path of the reaction tube 2011, and operational examples of the reaction tube 2011 of the reaction tube transportation arm 214 of the automatic analyzing apparatus 1 according to the present embodiment, and is a figure corresponding to FIG. 4 of the first embodiment described above. FIG. 15 is a flowchart that describes a content of the reaction tube transportation control process when dispensing the subject sample, executed in the automatic analyzing apparatus 1 according to the third embodiment, and is a figure corresponding to FIG. 5 of the first embodiment described above. The reaction tube transportation control process is a process executed by the system control function 91 and the dispensing control function 92 of the control circuit 9. Note that, since content of the reaction tube transportation control function when dispensing the standard sample is the same as content of the reaction tube transportation control process according to the first embodiment described above, the description will be omitted.

As shown in FIG. 14, the reaction tube supplying position P11, the standard sample dispensing position P12, the subject sample dispensing position P13, the first reagent dispensing position P14, and the reaction tube placement position P15 are set on the rotational trajectory of the transportation path TP of the reaction tube 2011 of the reaction tube transportation arm 214. Note that an arc-shaped dotted line shown in FIG. 4 indicates the rotational trajectory of the transportation path TP of the reaction tube 2011 of the reaction tube transportation arm 214. Likewise, a dashed line shown in FIG. 14 indicates the rotational trajectory of the subject sample dispensing arm 207b. The black circles indicate the center of rotation of the subject sample dispensing arm 207b and the second reagent dispensing arm 212. Furthermore, portions surrounded by circles shown in FIG. 14 indicate the reaction tube supplying position P11, the standard sample dispensing position P12, the subject sample dispensing position P13, the first reagent dispensing position P14, and the reaction tube placement position P15.

Likewise, as shown in FIG. 14, in the automatic analyzing apparatus 1 according to the present embodiment, the reaction tube supplying position P11 and the subject sample dispensing position P13 are the same positions. For this reason, when dispensing the subject sample to the reaction tube 2011, first, the subject sample dispensing arm 207b rotates and moves the subject sample dispensing probe 208b to the reaction tube supplying position P11 which is the subject sample dispensing position P13. Next, the subject sample dispensing arm 207b moves downward at the reaction tube supplying position P11 which is the subject sample dispensing position P13, and lowers the subject sample dispensing probe 208b such that the tip of the subject sample dispensing probe 208b is brought in contact with the bottom portion of the reaction tube 2011. The subject sample is then dispensed to the reaction tube 2011. After the subject sample has been dispensed to the reaction tube 2011, the subject sample dispensing arm 207b moves upward and pulls out the subject sample dispensing probe 208b from the reaction tube 2011. The reaction tube transportation arm 214 moves in the horizontal direction and holds the reaction tube 2011 at the reaction tube supplying position P11. Then, the reaction tube transportation arm 214 transports the reaction tube 2011 for which the subject sample has been dispensed to the first reagent dispensing position P14 or the reaction tube placement position P15.

Note that, since operational examples of the reaction tube transportation arm 214 when dispensing the standard sample, when dispensing the first reagent, and when placing the reaction tube 2011 to the reaction disk 201 are the same as operational examples of the reaction tube transportation arm 214 according to the first embodiment, description will be omitted.

Likewise, when dispensing the sample, the reaction tube transportation arm 214 transports the reaction tube 2011 held at the reaction tube supplying position P11 to the first reagent dispensing position P14, and after the first reagent is dispensed to the reaction tube 2011 at the first reagent dispensing position P14, the reaction tube transportation arm 214 may transport the reaction tube 2011 for which the first reagent has been dispensing to the sample dispensing position.

Next, the flowchart of FIG. 15 will be used to describe about the control of the reaction tube transportation arm 214 when dispensing the subject sample according to the present embodiment. When the reaction tube transportation control process according to the present embodiment shown in FIG. 15 begins, the system control function 91 controls the subject sample dispensing arm 207b and the dispensing control function 92 to move the subject sample dispensing probe 208b to the reaction tube supplying position P11, which is the subject sample dispensing position P13, and dispense the subject sample to the reaction tube 2011 (Step S51).

Specifically, the system control function 91 controls the drive mechanism 4 to rotate the subject sample dispensing arm 207b and move the subject sample dispensing probe 208b to the reaction tube supplying position P11. The system control function 91 controls the subject sample dispensing arm 207b to lower the subject sample dispensing probe 208b such that the tip of the subject sample dispensing probe 208b is brought in contact with the bottom portion of the reaction tube 2011 at the reaction tube supplying position P11 which is the standard sample dispensing position P13. Then, the dispensing control function 92 controls the subject sample dispensing probe 208b to dispense the subject sample to the reaction tube 2011 supplied to the reaction tube supplying position P11. After the subject sample has been dispensed, the system control function 91 controls the subject sample dispensing arm 207b to raise the subject sample dispensing arm 207b and to pull out the subject sample dispensing probe 208b from the reaction tube 2011. Then, the system control function 91 controls the subject sample dispensing arm 207b to rotate the subject sample dispensing arm 207b and arrange the subject sample dispensing probe 208b at the subject sample aspiration position.

Note that the arrangement of the subject sample dispensing probe 208b relative to the bottom portion of the reaction tube 2011 arranged on the reaction tube supplying position P11, which is the subject sample dispensing position P13, is arbitrary. For instance, the system control function 91, instead of controlling the subject sample dispensing arm 207b to lower the subject sample dispensing probe 208b such that the tip of the subject sample dispensing probe 208b is brought in contact with the bottom portion of the reaction tube 2011, may control the subject sample dispensing arm 207b to lower the subject sample dispensing probe 208b such that the tip of the subject sample dispensing probe 208b is located in the vicinity of the bottom portion of the reaction tube 2011. Here, to locate in the vicinity of the bottom portion of the reaction tube 2011, for instance, is to arrange the tip of the subject sample dispensing probe 208b at a position separated by a predetermined distance above from the bottom portion of the sample dispensing probe.

Next, the system control function 91 of the control circuit 9 controls the reaction tube transportation arm 214 to move the reaction tube holder to the reaction tube supplying position P11 (Step S53). That is to say, the system control function 91 controls the drive mechanism 4 to rotate the transportation arm of the reaction tube transportation arm 214 and move the reaction tube holder to the reaction tube supplying position P11 of FIG. 14.

Next, the system control function 91 of the control circuit 9 causes the reaction tube holder to hold the reaction tube 2011 (Step S55). That is to say, the system control function 91 of the control circuit 9 controls the reaction tube holder to hold the reaction tube 2011 for which the subject sample has been dispensed at the reaction tube supplying position P11 of FIG. 14. The process of Step S23 to Step S33 after this Step S55 is the same as the reaction tube transportation control process of the first embodiment described above, and after the reaction tube 2011 is placed on the reaction disk 201 at Step S33, the reaction tube transportation control process according to the first embodiment is ended.

As described above, according to the automatic analyzing apparatus 1 in the present embodiment, since the reaction tube transportation arm 214 transports the reaction tube 2011 to the reaction tube supplying position P11, the standard sample dispensing position P12, the first reagent dispensing position P14, and the reaction tube placement position P15 on the transportation path TP same as in the first embodiment described above, there is no need to provide a moving mechanism in the horizontal direction to the standard sample dispensing probe 206 and the first reagent dispensing probe 210, and the number of parts of the automatic analyzing apparatus 1 may be reduced. Likewise, since the reaction tube supplying position P11 and the subject sample dispensing position P13 became the same position by providing the moving mechanism in the horizontal direction to the subject sample dispensing arm 207b, the movement from the reaction tube supplying position P11 to the standard sample dispensing position P13 may be omitted, and a transportation distance of the reaction tube 2011 of the reaction tube transportation arm 214 may be shortened. As a result, the automatic analyzing apparatus 1 may be miniaturized.

### Modified First Example According to First to Third Embodiments

When the reagent is dispensed in the automatic analyzing apparatus 1 according to the first to the third embodiments described above, it is also possible to modify to lower the reaction tube 2011 in response to the height of the liquid surface of the liquid mixture of the sample and reagent. The detailed description different from a description of the first embodiment described above will be made below as a modified first example when applying this modified example to the first embodiment.

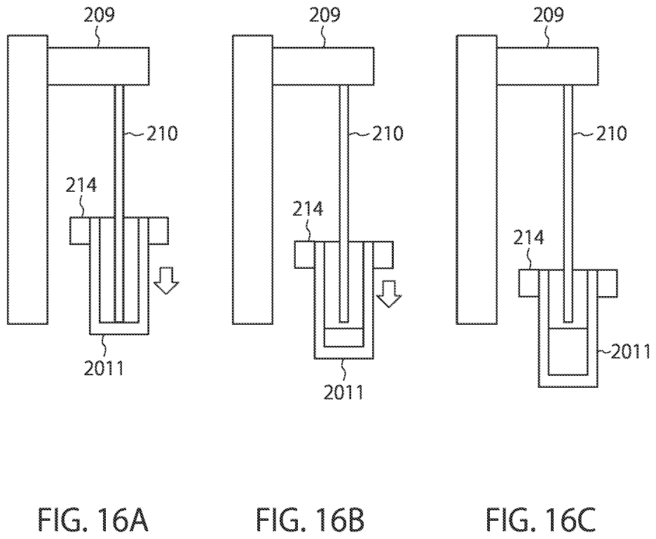

FIG. 16 is a schematic diagram that schematically illustrates arrangements of the reaction tube 2011 and the first reagent dispensing probe 210 arranged on the first reagent dispensing position P14 among the reagent dispensing positions in the automatic analyzing apparatus 1 according to the modified first example of the first embodiment, and is a diagram corresponding to FIG. 9 according to the first embodiment described above.

First, as shown in FIG. 16A, the system control function 91 controls the reaction tube transportation arm 214 at the first reagent dispensing position P14 among the reagent dispensing positions before starting to dispense the first reagent, to raise the reaction tube 2011 such that the bottom portion of the reaction tube 2011 arranged on the first reagent dispensing position P14 is brought in contact with the tip of the first reagent dispensing probe 210. Note that the arrangement of the tip of the first reagent dispensing probe 210 relative to the reaction tube 2011 arranged on the first reagent dispensing position P14 before starting to dispense the first reagent, is arbitrary. For instance, the system control function 91, instead of controlling the reaction tube transportation arm 214 to raise the reaction tube 2011 such that the bottom portion of the reaction tube 2011 arranged on the first reagent dispensing position 210 is brought in contact with the tip of the first reagent dispensing probe 210, may control the reaction tube transportation arm 214 to raise the reaction tube 2011 so such that the bottom portion of the reaction tube 2011 arranged on the first reagent dispensing position P14 is located in the vicinity of the tip of the first reagent dispensing probe 210.

Next, the system control function 91, while the first reagent is dispensed to the reaction tube 2011, controls the reaction tube transportation arm 214 and dispensing control function 92 to lower the reaction tube 2011 and dispense the first reagent in response to the height of the liquid surface of the liquid mixture of the sample and reagent in the reaction tube 2011. That is to say, as shown in FIG. 16B, the system control function 91, while the first reagent is dispensed to the reaction tube 2011 by the dispensing control function 92, controls the reaction tube transportation arm 214 to lower the reaction tube 2011 so as to dispense the first reagent at a speed identical or similar to a raising speed of the liquid surface of the liquid mixture based on a dispensing speed of reagent preset for each inspection item. By this, as shown in FIG. 16C, the system control function 91 may control the dispensing control function 92 to dispense the first reagent to the reaction tube 2011 while keeping a relative position between the tip of the first reagent dispensing probe 210 and the liquid surface of the liquid mixture.

As described above, in the automatic analyzing apparatus 1 according to the modified first example of the first embodiment, since the system control function 91 controls the reaction tube transportation arm 214 before starting to dispense the first reagent, to raise the reaction tube 2011 such that the bottom portion of the reaction tube 2011 arranged on the first reagent dispensing position 210 is brought in contact with the tip of the first reagent dispensing probe 210, and since the system control function 91 controls the reaction tube transportation arm 214 and dispensing control function 92, while the first reagent is dispensed to the reaction tube 2011, to lower the reaction tube 2011 and dispense the reagent to the reaction tube 2011 in response to the height of the liquid surface of the liquid mixture of the sample and reagent in the reaction tube 2011, it is possible to bring close the liquid surface of the liquid mixture with the tip of the first reagent dispensing probe 210 and dispense the first reagent. As a result, the splattering of reagents may be reduced.

Note that the description about the modified first example described above may also be applied when the system control function 91 controls the reaction tube transportation arm 214 to transport the reaction tube 2011 to the second reagent dispensing position and dispense the second reagent. Likewise, although the description about the modified first example described above is a description for a case applied to the first embodiment, it is clear that the present modified example may also be applied to the second embodiment and the third embodiment.

### Modified Second Example According to First to Third Embodiments

In the automatic analyzing apparatus 1 according to the first to the third embodiments described above, when the reaction tube transportation arm 214 comprises the tilting mechanism that tilts the reaction tube 2011, it is also possible to modify to tilt the reaction tube 2011 before starting to dispense the reagent, such that the reagent is dispensed to the inner wall of the reaction tube 2011. The detailed description different from a description of the first embodiment described above will be made below as a modified second example when applying this modified example to the first embodiment.

The reaction tube transportation arm 214 of the modified second example according to the first embodiment transports the reaction tube 2011 from the reaction tube supplier 204 to the reaction disk 201 by the drive mechanism 4. For instance, the reaction tube transportation arm 214 comprises the reaction tube holder to hold the reaction tube 2011, one transportation arm to rotate and vertically move the reaction tube holder, and the tilting mechanism to tilt the reaction tube 2011 relative to the reagent dispensing probe. The reaction tube holder, for instance, is the gripper. The transportation arm is provided to be vertically movable in the perpendicular direction and rotatable in the horizontal direction by the drive mechanism 4. The tilting mechanism is a mechanism that tilts the reaction tube 2011 under the control of the control circuit 9, and for instance, consists of the motor. Note that the reaction tube transportation arm 214 is one example of the reaction tube transportation mechanism. Likewise, the number of the transportation arm that configures the reaction tube transportation arm 214 is arbitrary. For instance, the reaction tube transportation arm 214 may be configured by the plurality of transportation arms.

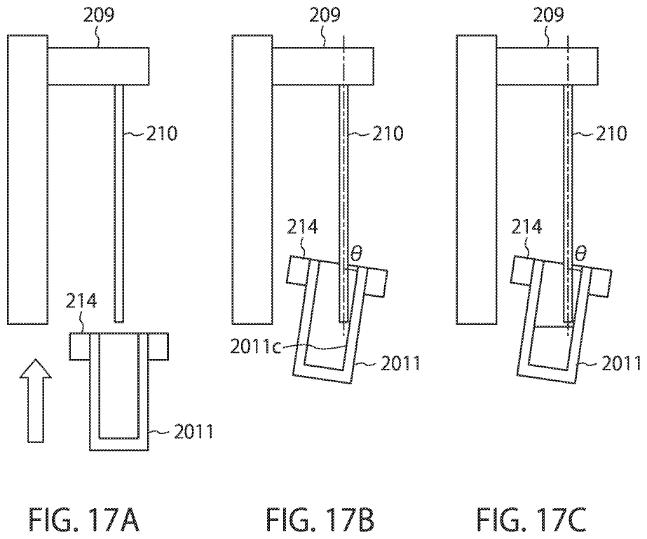

FIG. 17 is a schematic diagram that schematically illustrates arrangements of the reaction tube 2011 and the first reagent dispensing probe 210 arranged on the first reagent dispensing position P14 among the reagent dispensing positions in the automatic analyzing apparatus 1 according to the modified second example of the first embodiment, and is a diagram corresponding to FIG. 9 of the first embodiment described above.

First, as shown in FIG. 17A, before starting to dispense the first reagent, at the first reagent dispensing position P14 among the reagent dispensing positions, the system control function 91 controls the reaction tube transportation arm 214 to raise the reaction tube 2011. Then, the system control function 91 controls the reaction tube transportation arm 214 to stop raising the reaction tube 2011 when the tip of the first reagent dispensing probe 210 is arranged on a position in the vicinity of the liquid surface of the liquid mixture of the sample and the first reagent when the first reagent is completely dispensed. Here, the position in the vicinity of the liquid surface of the sample and the first reagent when the first reagent is completely dispensed, as shown in FIG. 17, is a position above the height of the liquid surface of the liquid mixture based on the sample amount and the reagent amount dispensed in the reaction tube 2011 preset for each inspection item, and is the position in the vicinity of the liquid surface of the liquid mixture.

Next, as shown in FIG. 17B, the system control function 91, before starting to dispense the first reagent at the position where a rising of the reaction tube 2011 has been stopped, controls the tilting mechanism of the reaction tube transportation arm 214 to tilt the reaction tube 2011 so as to have an angle θ relative to a central axis of the first reagent dispensing probe 210. By this, the first reagent is dispensed to the inner wall 2011c of the reaction tube 2011. Note that the dashed line shown in FIG. 17 indicates the central axis of the first reagent dispensing probe 210. Likewise, the angle θ tilting the reaction tube 2011, for instance, is between 1°˜40°.

As described above, in the automatic analyzing apparatus 1 according to the modified first example of the first embodiment, since the system control function 91 controls the tilting mechanism of the reaction tube transportation arm 214 before starting to dispense the first reagent, to raise the reaction tube 2011 such that the tip of the first reagent dispensing probe 210 is arranged on the position in the vicinity of the liquid surface of the liquid mixture of the sample and the first reagent when the first reagent is completely dispensed, and tilt the reaction tube 2011 by the tilting mechanism so as to dispense the first reagent to the inner wall 2011c of the reaction tube 2011c, it is possible to bring close the inner wall 2011c of the reaction tube 2011 with the tip of the first reagent dispensing probe 210 and dispense the first reagent. As a result, the splattering of reagents may be reduced.

Note that the description about the modified second example described above may also be applied when the system control function 91 controls the reaction tube transportation arm 214 to transport the reaction tube 2011 to the second reagent dispensing position and dispense the second reagent. Likewise, although the description about the modified second example described above is the description applied to the first embodiment, it is clear that the present modified example may also be applied to the second embodiment and the third embodiment.

### Modified Third Example According to First to Third Embodiments

In the automatic analyzing apparatus 1 according to the first to the third embodiments described above, when the reaction tube transportation arm 214 comprises the tilting mechanism that tilts the reaction tube 2011, it is also possible to modify to tilt the reaction tube 2011 before starting to dispense the reagent such that the reagent is dispensed to the inner wall of the reaction tube 2011, and lower the reaction tube 2011 in response to the height of the liquid surface of the liquid mixture of the sample and reagent while the reagent is dispensed. The detailed description different from a description of the first embodiment described above will be made below as a modified third example when applying this modified example to the first embodiment.

The reaction tube transportation arm 214 of the modified third example according to the first embodiment transports the reaction tube 2011 from the reaction tube supplier 204 to the reaction disk 201 by the drive mechanism 4. For instance, the reaction tube transportation arm 214 comprises the reaction tube holder to hold the reaction tube 2011, one transportation arm to rotate and vertically move the reaction tube holder, and the tilting mechanism to tilt the reaction tube 2011 relative to the reagent dispensing probe. The reaction tube holder, for instance, is the gripper. The transportation arm is provided to be vertically movable in the perpendicular direction and rotatable in the horizontal direction by the drive mechanism 4. The tilting mechanism is the mechanism that tilts the reaction tube 2011 under the control of the control circuit 9, and for instance, consists of the motor. Note that the reaction tube transportation arm 214 is one example of the reaction tube transportation mechanism. Likewise, the number of the transportation arm that configures the reaction tube transportation arm 214 is arbitrary. For instance, the reaction tube transportation arm 214 may be configured by the plurality of transportation arms.

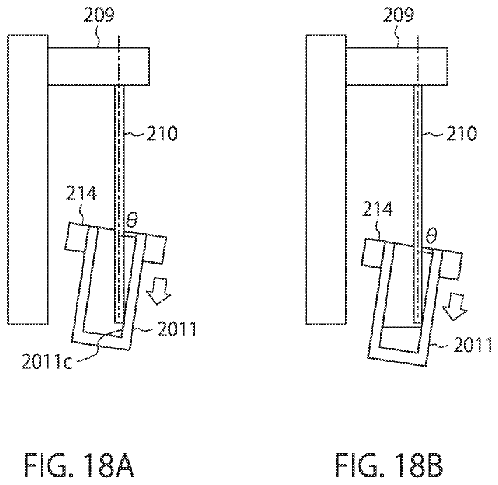

FIG. 18 is a schematic diagram that schematically illustrates arrangement of the reaction tube 2011 and the first reagent dispensing probe 210 arranged on the first reagent dispensing position P14 among the reagent dispensing positions of the automatic analyzing apparatus 1 according to the modified third example of the first embodiment, and is a diagram corresponding to FIG. 9 of the first embodiment described above.

First, as shown in FIG. 18A, before starting to dispense the first reagent at the first reagent dispensing position P14 among the reagent dispensing positions, the system control function 91 controls the reaction tube transportation arm 214 to raise the reaction tube 2011 such that the bottom portion of the reaction tube 2011 arranged on the first reagent dispensing position P14 is brought in contact with the tip of the first reagent dispensing probe 210. Then, the system control function 91, before starting to dispense the first reagent at a position where the reaction tube 2011 has been raised, controls the tilting mechanism of the reaction tube transportation arm 214 to tilt the reaction tube 2011 so as to have the angle θ relative to the central axis of the first reagent dispensing probe 210. As such, by tilting the reaction tube 2011, it is possible to dispense the first reagent to the inner wall 2011c of the reaction tube 2011. Note that the dashed line shown in FIG. 18 indicates the central axis of the first reagent dispensing probe 210. Likewise, the angle θ tilting the reaction tube 2011, for instance, is 1°˜40°.

Furthermore, the arrangement of the tip of the first reagent dispensing probe 210 relative to the reaction tube 2011 arranged on the first reagent dispensing position P14 before starting to dispense the first reagent is arbitrary. For instance, the system control function 91, instead of controlling the reaction tube transportation arm 214 to raise the reaction tube 2011 such that the bottom portion of the reaction tube 2011 arranged on the first reagent dispensing position P14 is brought in contact with the tip of the first reagent dispensing probe 210, may control the reaction tube transportation arm 214 to raise the reaction tube 2011 such that the bottom portion of the reaction tube 2011 arranged on the first reagent dispensing position P14 is located in the vicinity of the tip of the first reagent dispensing probe 210.

Next, the system control function 91 controls the reaction tube transportation arm 214 and the dispensing control function 92 while the first reagent is dispensed to the reaction tube 2011 to lower the reaction tube 2011 and dispense the first reagent in response to the height of the liquid surface of the liquid mixture of the sample and reagent in the reaction tube 2011. That is to say, as shown in FIG. 18B, the system control function 91 controls the reaction tube transportation arm 214 while the first reagent is dispensed to the reaction tube 2011 by the dispensing control function 92 to lower the reaction tube 2011 at the speed identical or similar to the raising speed of the liquid surface of the liquid mixture based on the dispensing speed of reagent preset for each inspection item to dispense the first reagent.

As described above, in the automatic analyzing apparatus 1 according to the modified third example of the first embodiment, since the system control function 91 controls the reaction tube transportation arm 214 before starting to dispense the first reagent, to raise the reaction tube 2011 such that the bottom portion of the reaction tube 2011 arranged on the first reagent dispensing position P14 is brought in contact with the tip of the first reagent dispensing probe 210 and tilt the reaction tube 2011 by the tilting mechanism of the reaction tube transportation arm 214, and since the system control function 91 controls the reaction tube transportation arm 214 and dispensing control function 92, while the first reagent is dispensed to the reaction tube 2011 by the dispensing control function 92, to lower the reaction tube 2011 in response to the height of the liquid surface of the liquid mixture of the sample and reagent in the reaction tube 2011, and to dispense the first reagent to the reaction tube 2011, it is possible to bring close the liquid surface of the liquid mixture with the tip of the first reagent dispensing probe 210 and dispense the first reagent. As a result, the splattering of the reagents may be reduced. Likewise, since there is no need to provide the mechanism that vertically moves the first reagent dispensing probe, the number of parts of the automatic analyzing apparatus 1 may be reduced. As a result, the automatic analyzing apparatus 1 may be miniaturized.

Note that the description about the modified third example described above may also be applied when the system control function 91 controls the reaction tube transportation arm 214 to transport the reaction tube 2011 to the second reagent dispensing position, and dispense the second reagent. Likewise, although the description about the modified third example described above is a description for a case applied to the first embodiment, it is clear that the present modified example may also be applied to the second embodiment and the third embodiment.

### Modified Fourth Example According to First to Third Embodiments

In the automatic analyzing apparatus 1 according to the first to the third embodiments described above, when the reaction tube transportation arm 214 comprises the tilting mechanism that tilts the reaction tube 2011, it is also possible to modify to tilt the reaction tube 2011 by the tilting mechanism before starting to dispense the reagent, and transport the reaction tube 2011 so as to arrange the opening of the reaction tube 2011 separate from the tip of the first reagent dispensing probe 210 and arrange the tip of the first reagent dispensing probe 210 above the position where the liquid surface of the liquid mixture of the sample and the first reagent, when the first reagent is completely dispensed, is presumed to contact the inner wall of the reaction tube 2011. Hereinafter, parts that differ from that of the first embodiment described above will be described as a modified fourth example when applying this modified example to the first embodiment.

The reaction tube transportation arm 214 of the modified fourth example according to the first embodiment transports the reaction tube 2011 from the reaction tube supplier 204 to the reaction disk 201 by the drive mechanism 4. For instance, the reaction tube transportation arm 214 comprises the reaction tube holder to hold the reaction tube 2011, one transportation arm to rotate and vertically move the reaction tube holder, and the tilting mechanism to tilt the reaction tube 2011 relative to the reagent dispensing probe. The reaction tube holder, for instance, is the gripper. The transportation arm is provided to be vertically movable in the perpendicular direction and rotatable in the horizontal direction by the drive mechanism 4. The tilting mechanism is the mechanism that tilts the reaction tube 2011 under the control of the control circuit 9, and for instance, consists of the motor. Note that the reaction tube transportation arm 214 is one example of the reaction tube transportation mechanism. Likewise, the number of the transportation arm that configures the reaction tube transportation arm 214 is arbitrary. For instance, the reaction tube transportation arm 214 may be configured by the plurality of transportation arms.

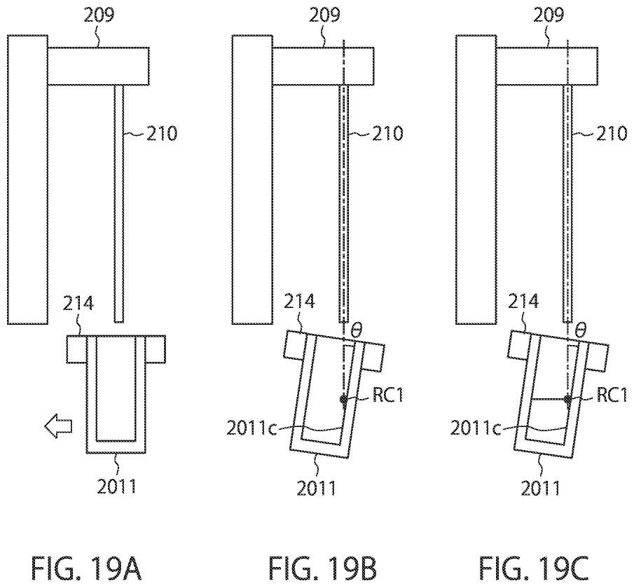

FIG. 19 is a schematic diagram that schematically illustrates arrangements of the reaction tube 2011 and the first reagent dispensing probe 210 arranged on the first reagent dispensing position P14 among the reagent dispensing positions in the automatic analyzing apparatus 1 according to the modified fourth example of the first embodiment, and is a diagram corresponding to FIG. 9 of the first embodiment described above.

First, as shown in FIG. 19A, the system control function 91 controls the reaction tube transportation arm 214 to transport the reaction tube 2011 to the first reagent dispensing position P14 among the reagent dispensing positions before starting to dispense the first reagent. Next, as shown in FIG. 19B, the system control function 91 controls the tilting mechanism of the reaction tube transportation arm 214 to tilt the reaction tube 2011 before starting to dispense the first reagent so as to have the angle θ relative to the central axis of the first reagent dispensing probe 210. At this time, the system control function 91 controls the reaction tube transportation arm 214 to arrange the opening of the reaction tube 2011 separate from the tip of the first reagent dispensing probe 210. Furthermore, the system control function 91 controls the reaction tube transportation arm 214 to transport the reaction tube 2011 such that the tip of the first reagent dispensing probe 210 is arranged above the position where the liquid surface of the liquid mixture of the sample and the first reagent in the reaction tube 2011, when the first reagent is completely dispensed, is presumed to contact the inner wall 2011c of the reaction tube 2011. Note that the dashed line shown in FIG. 19 indicates the central axis of the first reagent dispensing probe 210. Likewise, the angle θ tilting the reaction tube 2011, for instance, is 1°˜40°.

Then, the dispensing control function 92 dispenses the first reagent to the reaction tube 2011. That is to say, in the automatic analyzing apparatus 1 according to the modified fourth example of the first embodiment, the dispensing control function 92 dispenses the first reagent to the reaction tube 2011 without raising the reaction tube 2011 transported to the first reagent dispensing position P14.

Here, the position where the liquid surface of the liquid mixture of the sample and the first reagent in the reaction tube 2011 when the first reagent is completely dispensed is presumed to contact the inner wall 2011c of the reaction tube 2011, as shown in FIG. 19C, is a position where the liquid surface of the liquid mixture, based on the sample amount and the reagent amount dispensed in the reaction tube 2011 preset for each inspection item, is presumed to contact the inner wall 2011c of the reaction tube 2011. The black circles indicated in FIGS. 19B and 19C indicates the position RC1 where the liquid surface of the liquid mixture of the sample and the first reagent in the reaction tube 2011, when the first reagent is completely dispensed, is presumed to contact the inner wall 2011c of the reaction tube 2011.

As described above, in the automatic analyzing apparatus 1 according to the modified fourth example of the first embodiment, since the system control function 91 controls the reaction tube transportation arm 214 before starting to dispense the first reagent at the first reagent dispensing position P14, to tilt the reaction tube 2011 and dispense the first reagent such that the opening of the reaction tube 2011 is arranged separately from the tip of the first reagent dispensing probe 210 and such that the tip of the first reagent dispensing probe 210 is arranged above the position RC1 where the liquid surface of the liquid mixture of the sample and the first reagent in the reaction tube 2011 is presumed to contact the inner wall 2011c of the reaction tube 2011 when the first reagent is completely dispensed, it is possible to reduce the splattering of reagents without moving the reaction tube 2011 vertically.

Note that the description about the modified fourth example described above may also be applied when the system control function 91 controls the reaction tube transportation arm 214 to transport the reaction tube 2011 to the second reagent dispensing position, and dispense the second reagent. Likewise, although the description about the modified fourth example described above is a description for a case applied to the first embodiment, it is clear that the present example may also be applied to the second embodiment and the third embodiment.

### Modified Fifth Example According to First to Third Embodiments

In the automatic analyzing apparatus 1 according to the first to the third embodiments described above, when the reaction tube transportation arm 214 comprises the tilting mechanism that tilts the reaction tube 2011, it is also possible to modify to tilt the reaction tube 2011 before starting to dispense the reagent, to arrange the opening of the reaction tube 2011 separate from the tip of the first reagent dispensing probe 210, and, while the reagent is dispensed, to move the reaction tube 2011 such that the tip of the first reagent dispensing probe 210 is arranged above the position where the liquid surface of the liquid mixture of the sample and the first reagent in the reaction tube 2011 contacts the inner wall of the reaction tube 2011. The detailed description different from a description of the first embodiment described above will be made below as a modified fifth example when applying this modified example to the first embodiment.

The reaction tube transportation arm 214 of the modified fifth example according to the first embodiment transports the reaction tube 2011 from the reaction tube supplier 204 to the reaction disk 201 by the drive mechanism 4. For instance, the reaction tube transportation arm 214 comprises the reaction tube holder to hold the reaction tube 2011, one transportation arm to rotate and vertically move the reaction tube holder, and the tilting mechanism to tilt to the reaction tube 2011 relative to the reagent dispensing probe. The reaction tube holder, for instance, is the gripper. The transportation arm is provided to be vertically movable in the perpendicular direction and rotatable in the horizontal direction by the drive mechanism 4. The tilting mechanism is the mechanism that tilts the reaction tube 2011 under the control of the control circuit 9, and for instance, consists of the motor. Note that the reaction tube transportation arm 214 is one example of the reaction tube transportation mechanism. Likewise, the number of the transportation arm that configures the reaction tube transportation arm 214 is arbitrary. For instance, the reaction tube transportation arm 214 may be configured by the plurality of transportation arms.

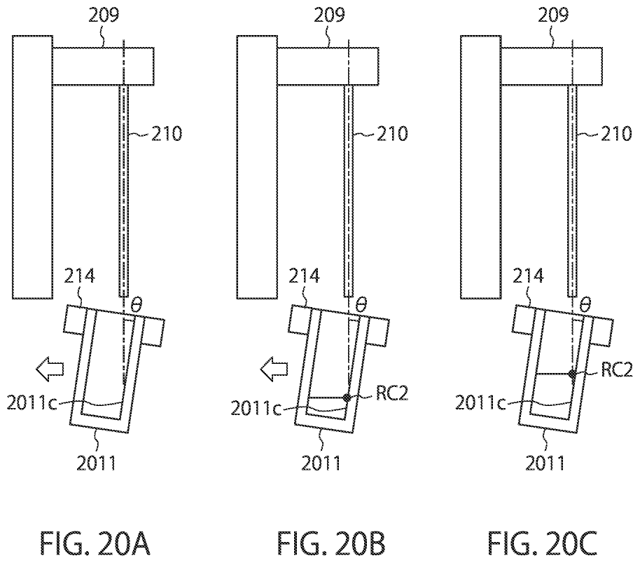

FIG. 20 is a schematic diagram that schematically illustrates arrangements of the reaction tube 2011 and the first reagent dispensing probe 210 arranged on the first reagent dispensing position P14 among the reagent dispensing positions in the automatic analyzing apparatus 1 according to the modified fifth example of the first embodiment, and is a diagram corresponding to FIG. 9 of the first embodiment described above.

First, as shown in FIG. 20A, before starting to dispense the first reagent at the first reagent dispensing position P14 among the reagent dispensing positions, the system control function 91 controls the reaction tube transportation arm 214 to transport the reaction tube 2011 to the first reagent dispensing position P14 among the reagent dispensing positions. Next, the system control function 91 controls the tilting mechanism of the reaction tube transportation arm 214, before starting to dispense the first reagent, to tilt the reaction tube 2011 so as to have the angle θ relative to the central axis of the first reagent dispensing probe 210. At this time, the opening of the reaction tube 2011 is arranged separately from the tip of the first reagent dispensing probe 210, and the tip of the first reagent dispensing probe 210 is arranged above a position where the bottom portion of the reaction tube 2011 and the inner wall 2011c of the reaction tube 2011 intersect. Note that the dashed line shown in FIG. 20 indicates the central axis of the first reagent dispensing probe 210. Likewise, the angle θ tilting the reaction tube 2011, for instance, is 1°˜40°.

Then, as shown in FIGS. 20B and C, while the reagent is dispensed, a horizontal position of a position RC2 where the liquid surface of the liquid mixture of the sample and the first reagent in the reaction tube 2011 changes in response to the amount of the first reagent dispensed to the reaction tube. For this reason, the system control function 91 controls the reaction tube transportation arm 214 and the dispensing control function 92 while the first reagent is dispensed by the dispensing control function 92, to move the reaction tube 2011 and dispense the first reagent such that the tip of the first reagent dispensing probe 210 is arranged above the position RC2 where the liquid surface of the liquid mixture of the sample and the first reagent in the reaction tube 2011 contacts the inner wall 2011c of the reaction tube 2011. Note that the black circles shown in FIGS. 20B and C indicate the position RC2 where the liquid surface of the liquid mixture of the sample and the first reagent in the reaction tube 2011 contacts the inner wall 2011c of the reaction tube 2011.

As described above, in the automatic analyzing apparatus 1 according to the modified fifth example of the first embodiment, since the system control function 91 controls the reaction tube transportation arm 214 to tilt the reaction tube 2011 by the tilting mechanism of the reaction tube transportation arm 214 before starting to dispense the first reagent at the first reagent dispensing position P14, and since the system control function 91 controls the reaction tube transportation arm 214 and the dispensing control function 92 to arrange the opening of the reaction tube 2011 separate from the tip of the first reagent dispensing probe 210 while the reagent is dispensed, and dispenses the first reagent such that the tip of the first reagent dispensing probe 210 is arranged above the position RC2 where the liquid surface of the liquid mixture of the sample and the first reagent in the reaction tube 2011 contacts the inner wall 2011c of the reaction tube 2011, it is possible to reduce the splattering of reagents without moving the reaction tube 2011 vertically.

Note that the description about the modified fifth example described above may also be applied when the system control function 91 controls the reaction tube transportation arm 214, to transport the reaction tube 2011 to the second reagent dispensing position, and dispense the second reagent. Likewise, although the description about the modified fifth example described above is a description for a case applied to the first embodiment, it is clear that the present modified example may also be applied to the second embodiment and the third embodiment.

### Other Modified Examples According to First to Third Embodiments

The automatic analyzing apparatus 1 of the first to the third embodiments described above described about applying to the automatic analyzing apparatuses performing biochemical inspection, but embodiments are not limited to this. That is to say, the first to the third embodiments may be applied to automatic analyzing apparatuses performing blood coagulation analysis inspection.

Likewise, the automatic analyzing apparatus 1 of the first to the third embodiments described above described a case where inspection items of the two-reagent system is applied, but embodiments are not limited to this. For instance, inspection items of a one-reagent system may be applied. In this case, either one of the first reagent and the second reagent does not exist, thus not dispensed.

Note that the word “processor” used in above descriptions means circuits such as, for example, a Central Processing Unit (CPU), a Graphics Processing Unit (GPU), an Application Specific Integrated Circuit (ASIC), a programmable logic device (for example, a Simple Programmable Logic Apparatus (SPLD), a Complex Programmable Logic Apparatus (CPLD), and a Field Programmable Gate Array (FPGA)). The processor executes functions by reading and executing programs stored in the memory. Note that programs may be configured to be directly integrated in the processor instead of being storing in the memory. In this case, the processor realizes functions by reading and executing programs stored in the circuit. Note that the processor is not limited to the case arranged as a single processor circuit, but may be configured as a single processor by combining a plurality of independent circuits to realize functions. Furthermore, a plurality of component elements may be integrated into one processor to realize the functions.

While certain embodiments have been described, these embodiments have been presented by way of example only and are not intended to limit the scope of the inventions. The embodiments may be in a variety of other forms. Furthermore, various omissions, substitutions and changes may be made without departing from the spirit of the inventions. The embodiments and their modifications are included in the scope and the subject matter of the invention, and at the same time included in the scope of the claimed inventions and their equivalents.

1. An automatic analyzing apparatus, comprising:
a reaction disk on which a reaction tube is placed;
a reaction tube transportation mechanism configured to transport the reaction tube; and
a controller configured to control the reaction tube transportation mechanism to:
transport the reaction tube to at least one of a sample dispensing position and a reagent dispensing position, the sample dispensing position being a position where a sample is dispensed and the reagent dispensing position being a position where a reagent is dispensed, and
transport to the reaction disk the reaction tube for which at least one of the sample and the reagent is dispensed.

2. The automatic analyzing apparatus of claim 1, further comprising a sample dispensing probe configured to dispense the sample to the reaction tube at the sample dispensing position,
wherein the controller is further configured to control the reaction tube transportation mechanism and a dispensing controller that controls a dispensation to raise the reaction tube and dispense the sample at the sample dispensing position such that a bottom portion of the reaction tube is brought in contact with a tip of the sample dispensing probe or that the bottom portion of the reaction tube is located in a vicinity of the tip of the sample dispensing probe.

3. The automatic analyzing apparatus of claim 1, further comprising:
a reaction tube supplier configured to supply the reaction tube at a reaction tube supplying position; and
a standard sample dispensing probe configured to:
be arranged above the reaction tube supplying position in the reaction tube supplier, and
dispense the standard sample to the reaction tube at a standard sample dispensing position among the sample dispensing position, the standard sample dispensing position being a position where a standard sample is dispensed,
wherein the controller, when dispensing the standard sample to the reaction tube, is further configured to control the reaction tube transportation mechanism and a dispensing controller that controls a dispensation to raise the reaction tube and dispense the standard sample at the standard sample dispensing position such that a bottom portion of the reaction tube is brought in contact with a tip of the standard sample dispensing probe or that the bottom portion of the reaction tube is located in a vicinity of the tip of the standard sample dispensing probe.

4. The automatic analyzing apparatus of claim 3, further comprising a subject sample dispensing probe configured to:
be arranged on a transportation path of the reaction tube of the reaction tube transportation mechanism, and
dispense the subject sample to the reaction tube at a subject sample dispensing position among the sample dispensing position, the subject sample dispensing position being a position where the subject sample is dispensed,
wherein the controller, when dispensing the subject sample to the reaction tube, is further configured to control the reaction tube transportation mechanism and the dispensing controller to raise the reaction tube and dispense the subject sample at the subject sample dispensing position such that a bottom portion of the reaction tube is brought in contact with a tip of the subject sample dispensing probe or that the bottom portion of the reaction tube is located in a vicinity of the tip of the subject sample dispensing probe.

5. The automatic analyzing apparatus of claim 4, wherein the standard sample dispensing position and the reaction tube supplying position are the same positions, and
wherein the controller is further configured to:
when dispensing the standard sample to the reaction tube, control the reaction tube transportation mechanism and the dispensing controller at the reaction tube supplying position, which is the standard sample dispensing position to raise the reaction tube and dispense the standard sample, and
when dispensing the subject sample to the reaction tube, control the reaction tube transportation mechanism and the dispensing controller to transport the reaction tube to the subject sample dispensing position and to raise the reaction tube and dispense the subject sample.

6. The automatic analyzing apparatus of claim 1, further comprising a subject standard dispensing probe configured to:
be arranged on a transportation path of the reaction tube of the reaction tube transportation mechanism, and
dispense the standard sample to the reaction tube at a standard sample dispensing position among the sample dispensing position, the standard sample dispensing position being a position where the standard sample is dispensed,
wherein the controller, when dispensing the standard sample to the reaction tube, is further configured to control the reaction tube transportation mechanism and a dispensing controller that controls a dispensation to raise the reaction tube to dispense the standard sample at the standard sample dispensing position such that a bottom portion of the reaction tube is brought in contact with a tip of the standard sample dispensing probe or that the bottom portion of the reaction tube is located in a vicinity of the tip of the standard sample dispensing probe.

7. The automatic analyzing apparatus of claim 6, further comprising:
a reaction tube supplier configured to supply the reaction tube at the reaction tube supplying position; and
a subject sample dispensing probe configured to:
be arranged on the transportation path of the reaction tube of the reaction tube transportation mechanism, and
dispense the subject sample to the reaction tube at the subject sample dispensing position among the sample dispensing position, the subject sample dispensing position being a position where a subject sample is dispensed,
wherein the subject sample dispensing position and the reaction tube supplying position are same positions, and
wherein the controller, when dispensing the subject sample to the reaction tube, is further configured to control to lower the subject sample dispensing probe and dispense the subject sample at the subject sample dispensing position such that the bottom portion of the reaction tube is brought in contact with the tip of the subject sample dispensing probe or that the tip of the subject sample dispensing probe is located in a vicinity of the bottom portion of the reaction tube.

8. The automatic analyzing apparatus of claim 7, wherein the controller is further configured to:
when dispensing the standard sample to the reaction tube, control the reaction tube transportation mechanism and the dispensing controller to transport the reaction tube to the standard sample dispensing position and to raise the reaction tube and dispense the standard sample, and
when dispensing the subject sample to the reaction tube, control at the reaction tube supplying position, which is the standard sample dispensing position, to lower the subject sample dispensing probe without raising the reaction tube, and to dispense the subject sample.

9. The automatic analyzing apparatus of claim 2, wherein the controller, after the sample has been dispensed into the reaction tube at the sample dispensing position, is configured to control the reaction tube transportation mechanism to transport the reaction tube to the reagent dispensing position.

10. The automatic analyzing apparatus of claim 1, further comprising a reagent dispensing probe configured to dispense the reagent to the reaction tube at the reagent dispensing position,
wherein the controller is further configured to control the reaction transportation mechanism and a dispensing controller that controls a dispensation to raise the reaction tube and dispense the reagent before starting to dispense the reagent at the reagent dispensing position such that a tip of the reagent dispensing probe is arranged on a position in a vicinity of a liquid surface of a liquid mixture of the sample and the reagent in the reaction tube when the first reagent is completely dispensed.

11. The automatic analyzing apparatus of claim 1, further comprising a reagent dispensing probe configured to dispense the reagent to the reaction tube at the reagent dispensing position,
wherein the controller is configured to control the reaction tube transportation mechanism and a dispensing controller that controls a dispensation to:
raise the reaction tube before starting to dispense the reagent at the reagent dispensing position such that a bottom portion of the reaction tube is brought in contact with a tip of the sample dispensing probe or that the bottom portion of the reaction tube is located in a vicinity of the tip of the sample dispensing probe, and
lower the reaction tube and dispense the reagent in response to the height of a liquid surface of a liquid mixture of the sample and the reagent in the reaction tube while the reagent is dispensed.

12. The automatic analyzing apparatus of claim 10, wherein the reaction tube transportation mechanism comprises a tilting mechanism configured to tilt the reaction tube relative to the reagent dispensing probe, and
wherein the controller is further configured to control the reaction tube transportation mechanism to tilt the reaction tube with the tilting mechanism at the sample dispensing position before starting to dispense the reagent such that the reagent is dispensed to an inner wall of the reaction tube.

13. The automatic analyzing apparatus of claim 1, further comprising a reagent dispensing probe configured to dispense the reagent to the reaction tube at the reagent dispensing position,
wherein the reaction tube transportation mechanism comprises a tilting mechanism configured to tilt the reaction tube relative to the reagent dispensing probe, and
wherein the controller is configured to control the reaction tube transportation mechanism and a dispensing controller that controls a dispensation at the reagent dispensing position to transport the reaction tube and dispense the reagent such that:
the reaction tube is tilted with the tilting mechanism before starting to dispense the reagent,
an opening of the reaction tube is arranged to separate from a tip of the reagent dispensing probe, and
the tip of the reagent dispensing probe is arranged above a position for which a liquid surface of a liquid mixture of the sample and the reagent in the reaction tube is presumed to contact with the inner wall of the reaction tube when the reagent is completely dispensed.

14. The automatic analyzing apparatus of claim 1, further comprising a reagent dispensing probe configured to dispense the reagent to the reaction tube at the reagent dispensing position,
wherein the reaction tube transportation mechanism comprises a tilting mechanism configured to tilt the reaction tube relative to the reagent dispensing probe, and
wherein the controller is configured to control the reaction tube transportation mechanism at the reagent dispensing position to move the reaction tube to dispense the reagent such that:
the reaction tube is tilted with the tilting mechanism before starting to dispense the reagent,
an opening of the reaction tube is arranged to separate from the tip of the reagent dispensing probe, and
the tip of the reagent dispensing probe is arranged above a position for which a liquid surface of a liquid mixture of the sample and the reagent in the reaction tube is presumed to contact with the inner wall of the reaction tube while the reagent is dispensed.

15. The automatic analyzing apparatus of claim 10, wherein the reagent dispensing probe is a first reagent dispensing probe configured to:
be arranged on a transportation path of the reaction tube, and
dispense a first reagent to the reaction tube at a first reagent dispensing position among the reagent dispensing position, the first reagent dispensing position being a position where the reagent is dispensed.

16. The automatic analyzing apparatus of claim 15, further comprising a second reagent dispensing probe configured to dispense a second reagent to the reaction tube placed on the reaction disk.

17. The automatic analyzing apparatus of claim 16, wherein the reaction tube transportation mechanism has a transportation arm configured to provide a rotational axis on one end and hold the reaction tube on another end,
wherein the transportation arm is configured to transport the reaction tube by rotating about the rotational axis, and
wherein at least one of the reagent dispensing position and the reaction tube placement position on which the reaction tube is placed, is configured to be placed on a rotational trajectory of the reaction tube of the transportation arm.
